(19) United States
(12) Patent Application Publication
(10) Pub. No.: US 2025/0378831 A1
(43) Pub. Date: Dec. 11, 2025

(54) TASK PERFORMANCE WITH SOFTWARE OBJECTS

(71) Applicant: Apple Inc., Cupertino, CA (US)

(72) Inventors: Michael A. GORBACH, Scotts Valley, CA (US); Pitiphong PHONGPATTRANONT, Campbell, CA (US); Kenneth A. YORK, San Jose, CA (US)

(21) Appl. No.: 18/972,206

(22) Filed: Dec. 6, 2024

Related U.S. Application Data
(60) Provisional application No. 63/657,701, filed on Jun. 7, 2024.

(51) Int. Cl. G10L 15/22; G06F 8/61

(52) U.S. Cl. CPC G10L 15/22; G06F 8/61; G10L 2015/223

(57) ABSTRACT

Systems and processes for operating an intelligent automated assistant are provided. Example methods include receiving a request from a user to perform an action using a particular software object, and in response to the request, determining an actionable intent corresponding to the action, determining whether and how to transfer the particular software object for use in executing the actionable intent, and executing the actionable intent using the particular software object.

### CROSS-REFERENCE TO RELATED APPLICATIONS

This application claims priority to U.S. Provisional Application Ser. No. 63/657,701, filed on Jun. 7, 2024, entitled “TASK PERFORMANCE WITH SOFTWARE OBJECTS,” the contents of which is hereby incorporated by reference for all purposes, as if fully set forth herein.

### FIELD

This relates generally to intelligent automated assistants and, more specifically, to task performance using software objects.

### BACKGROUND

Intelligent automated assistants (or digital assistants) can provide a beneficial interface between human users and electronic devices. Such assistants can allow users to interact with devices or systems using natural language in spoken and/or text forms. For example, a user can provide a speech input containing a user request to a digital assistant operating on an electronic device. The digital assistant can interpret the user's intent from the speech input and operationalize the user's intent into tasks. The tasks can then be performed by executing one or more services of the electronic device, and a relevant output responsive to the user request can be returned to the user.

Applications can also provide a wide array of functionality and content for electronic devices. An application can define tasks or services that can be executed within the application using content provided by the application. For example, a user can use a note-taking application to draft digital notes, a file storage application to manage digital files, a media player application to view and play media, and so forth. For example, a user can customize functionality and content on an electronic device by installing first- and/or third-party applications providing desired functionality and content.

### SUMMARY

Example methods are disclosed herein. An example method includes, at an electronic device having one or more processors, receiving a user request to perform an action with a respective software object, wherein the action corresponds to an intent object of an application; and in response to receiving the user request: in accordance with a determination that an entity type of the respective software object is included in a set of parameter types accepted by the intent object of the application: causing the application to perform the action with the respective software object; and in accordance with a determination that the entity type of the respective software object is not included in the set of parameter types accepted by the intent object of the application: converting the respective software object into a transferrable software object of a transferrable type selected from a set of transferrable parameter types for the respective software object; and providing the intent object of the application and the transferrable software object to the application to cause the application to perform the action with the transferrable software object.

Example non-transitory computer-readable media are disclosed herein. An example non-transitory computer-readable storage medium stores one or more programs. The one or more programs comprise instructions, which when executed by one or more processors of an electronic device, cause the electronic device to receive a user request to perform an action with a respective software object, wherein the action corresponds to an intent object of an application; and in response to receiving the user request: in accordance with a determination that an entity type of the respective software object is included in a set of parameter types accepted by the intent object of the application: cause the application to perform the action with the respective software object; and in accordance with a determination that the entity type of the respective software object is not included in the set of parameter types accepted by the intent object of the application: convert the respective software object into a transferrable software object of a transferrable type selected from a set of transferrable parameter types for the respective software object; and provide the intent object of the application and the transferrable software object to the application to cause the application to perform the action with the transferrable software object.

Example electronic devices are disclosed herein. An example electronic device comprises one or more processors; a memory; and one or more programs, where the one or more programs are stored in the memory and configured to be executed by the one or more processors, the one or more programs including instructions for receiving a user request to perform an action with a respective software object, wherein the action corresponds to an intent object of an application; and in response to receiving the user request: in accordance with a determination that an entity type of the respective software object is included in a set of parameter types accepted by the intent object of the application: causing the application to perform the action with the respective software object; and in accordance with a determination that the entity type of the respective software object is not included in the set of parameter types accepted by the intent object of the application: converting the respective software object into a transferrable software object of a transferrable type selected from a set of transferrable parameter types for the respective software object; and providing the intent object of the application and the transferrable software object to the application to cause the application to perform the action with the transferrable software object.

An example electronic device comprises means for receiving a user request to perform an action with a respective software object, wherein the action corresponds to an intent object of an application; and means for, in response to receiving the user request: in accordance with a determination that an entity type of the respective software object is included in a set of parameter types accepted by the intent object of the application: causing the application to perform the action with the respective software object; and in accordance with a determination that the entity type of the respective software object is not included in the set of parameter types accepted by the intent object of the application: converting the respective software object into a transferrable software object of a transferrable type selected from a set of transferrable parameter types for the respective software object; and providing the intent object of the application and the transferrable software object to the application to cause the application to perform the action with the transferrable software object.

Example methods are disclosed herein. An example method includes, at an electronic device having one or more processors, obtaining, from one or more applications, a set of software object representations, wherein obtaining the set of software object representations includes obtaining, from a first application, a representation of a first software object that identifies a first type of the first software object and a set of one or more transferrable types of the first software object; obtaining, from the one or more applications, a set of intent objects, wherein: obtaining the set of intent objects includes obtaining, from a second application different from the first application, a first intent object for performing a first action with the second application that accepts a set of one or more parameter types; and the set of one or more parameter types does not include the first type of the first software object; receiving a natural-language user request; in response to receiving the natural-language user request, generating a response plan including at least one intent object selected from the set of intent objects and at least one software object representation selected from the set of software object representations; and in accordance with a determination that the response plan includes the representation of the first software object and the first intent object for performing the first action with the second application: selecting, from the set of one or more transferrable types of the first software object, a first transferrable type, wherein the first transferrable type is included in the set of one or more parameter types; converting the first software object into a transferrable software object of the first transferrable type; and providing the first intent object of the application and the transferrable software object to the application to cause the application to perform the first action with the transferrable software object.

Example non-transitory computer-readable media are disclosed herein. An example non-transitory computer-readable storage medium stores one or more programs. The one or more programs comprise instructions, which when executed by one or more processors of an electronic device, cause the electronic device to obtain, from one or more applications, a set of software object representations, wherein obtaining the set of software object representations includes obtaining, from a first application, a representation of a first software object that identifies a first type of the first software object and a set of one or more transferrable types of the first software object; obtain, from the one or more applications, a set of intent objects, wherein: obtaining the set of intent objects includes obtaining, from a second application different from the first application, a first intent object for performing a first action with the second application that accepts a set of one or more parameter types; and the set of one or more parameter types does not include the first type of the first software object; receive a natural-language user request; in response to receiving the natural-language user request, generate a response plan including at least one intent object selected from the set of intent objects and at least one software object representation selected from the set of software object representations; and in accordance with a determination that the response plan includes the representation of the first software object and the first intent object for performing the first action with the second application: select, from the set of one or more transferrable types of the first software object, a first transferrable type, wherein the first transferrable type is included in the set of one or more parameter types; convert the first software object into a transferrable software object of the first transferrable type; and provide the first intent object of the application and the transferrable software object to the application to cause the application to perform the first action with the transferrable software object.

Example electronic devices are disclosed herein. An example electronic device comprises one or more processors; a memory; and one or more programs, where the one or more programs are stored in the memory and configured to be executed by the one or more processors, the one or more programs including instructions for obtaining, from one or more applications, a set of software object representations, wherein obtaining the set of software object representations includes obtaining, from a first application, a representation of a first software object that identifies a first type of the first software object and a set of one or more transferrable types of the first software object; obtaining, from the one or more applications, a set of intent objects, wherein: obtaining the set of intent objects includes obtaining, from a second application different from the first application, a first intent object for performing a first action with the second application that accepts a set of one or more parameter types; and the set of one or more parameter types does not include the first type of the first software object; receiving a natural-language user request; in response to receiving the natural-language user request, generating a response plan including at least one intent object selected from the set of intent objects and at least one software object representation selected from the set of software object representations; and in accordance with a determination that the response plan includes the representation of the first software object and the first intent object for performing the first action with the second application: selecting, from the set of one or more transferrable types of the first software object, a first transferrable type, wherein the first transferrable type is included in the set of one or more parameter types; converting the first software object into a transferrable software object of the first transferrable type; and providing the first intent object of the application and the transferrable software object to the application to cause the application to perform the first action with the transferrable software object.

An example electronic device comprises means for obtaining, from one or more applications, a set of software object representations, wherein obtaining the set of software object representations includes obtaining, from a first application, a representation of a first software object that identifies a first type of the first software object and a set of one or more transferrable types of the first software object; means for obtaining, from the one or more applications, a set of intent objects, wherein: obtaining the set of intent objects includes obtaining, from a second application different from the first application, a first intent object for performing a first action with the second application that accepts a set of one or more parameter types; and the set of one or more parameter types does not include the first type of the first software object; means for receiving a natural-language user request; means for, in response to receiving the natural-language user request, generating a response plan including at least one intent object selected from the set of intent objects and at least one software object representation selected from the set of software object representations; and means for, in accordance with a determination that the response plan includes the representation of the first software object and the first intent object for performing the first action with the second application: selecting, from the set of one or more transferrable types of the first software object, a first transferrable type, wherein the first transferrable type is included in the set of one or more parameter types; converting the first software object into a transferrable software object of the first transferrable type; and providing the first intent object of the application and the transferrable software object to the application to cause the application to perform the first action with the transferrable software object.

Transferring a software object to an application in a format the application can use to perform a requested task allows for more efficient and effective responses to user requests, for instance, reducing the amount of time and inputs needed to prepare the software object and/or provide the application with the software object in order to perform the task. Doing so also expands the functionality and content available to a digital assistant to use in responding to user requests to include functionality and content from a variety of applications. This leads to more enjoyable and efficient interactions between the user and a computer system (e.g., via the digital assistant), reducing the processing power and time required to perform tasks and respond to the user. In the case of battery-powered computer systems, this further conserves power and increases the battery life of the computer system.

### BRIEF DESCRIPTION OF THE DRAWINGS

FIG. 1 is a block diagram illustrating a system and environment for implementing a digital assistant, according to various examples.

FIG. 2A is a block diagram illustrating a portable multifunction device implementing the client-side portion of a digital assistant, according to various examples.

FIG. 2B is a block diagram illustrating exemplary components for event handling, according to various examples.

FIG. 3 illustrates a portable multifunction device implementing the client-side portion of a digital assistant, according to various examples.

FIG. 4A is a block diagram of an exemplary multifunction device with a display and a touch-sensitive surface, according to various examples.

FIGS. 4B-4G illustrate the use of Application Programming Interfaces (APIs) to perform operations.

FIG. 5A illustrates an exemplary user interface for a menu of applications on a portable multifunction device, according to various examples.

FIG. 5B illustrates an exemplary user interface for a multifunction device with a touch-sensitive surface that is separate from the display, according to various examples.

FIG. 6A illustrates a personal electronic device, according to various examples.

FIG. 6B is a block diagram illustrating a personal electronic device, according to various examples.

FIG. 7A is a block diagram illustrating a digital assistant system or a server portion thereof, according to various examples.

FIG. 7B illustrates the functions of the digital assistant shown in FIG. 7A, according to various examples.

FIG. 7C illustrates a portion of an ontology, according to various examples.

FIG. 8 illustrates an exemplary foundation system, according to various examples.

FIG. 9 illustrates a block diagram of a system for performing tasks using software objects, according to various examples.

FIGS. 10A-10H illustrate systems for performing tasks using software objects, according to various examples.

FIG. 11 illustrates a flow diagram for performing tasks using software objects, according to various examples.

FIG. 12A-12B illustrate a flow diagram for performing tasks using software objects, according to various examples.

### DETAILED DESCRIPTION

In the following description of examples, reference is made to the accompanying drawings in which are shown by way of illustration specific examples that can be practiced. It is to be understood that other examples can be used and structural changes can be made without departing from the scope of the various examples.

In response to receiving a user request to perform a task using a software object, an electronic device determines an intent corresponding to the requested task. The software object defines one or more transferrable types, which are object types the software object can be converted to from its current type, and the intent defines one or more accepted input types. If the intent cannot be performed using the software object as an input in the software object's current type, for instance, because the software object and intent are handled by different applications, the software object is converted to a transferrable type in order for the electronic device to perform the task using the converted software object. Converting a software object to use in performing a requested task as described herein provides an advantageous way of expanding the capability of a computer system to perform requested tasks using application-specific functionality and/or content while reducing the time and number of inputs needed to do so.

Although the following description uses terms “first,” “second,” etc. to describe various elements, these elements should not be limited by the terms. These terms are only used to distinguish one element from another. For example, a first input could be termed a second input, and, similarly, a second input could be termed a first input, without departing from the scope of the various described examples. The first input and the second input are both inputs and, in some cases, are separate and different inputs.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### 1. System and Environment

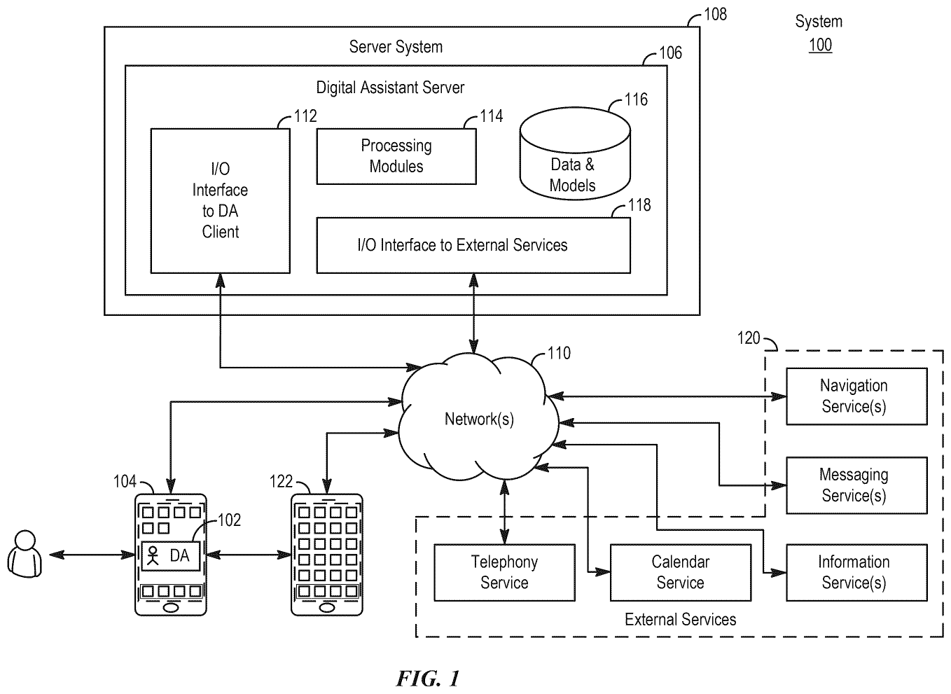

FIG. 1 illustrates a block diagram of system 100 according to various examples. In some examples, system 100 implements a digital assistant. The terms “digital assistant,” “virtual assistant,” “intelligent automated assistant,” or “automatic digital assistant” refer to any information processing system that interprets natural language input in spoken and/or textual form to infer user intent, and performs actions based on the inferred user intent. For example, to act on an inferred user intent, the system performs one or more of the following: identifying a task flow with steps and parameters designed to accomplish the inferred user intent, inputting specific requirements from the inferred user intent into the task flow; executing the task flow by invoking programs, methods, services, APIs, or the like; and generating output responses to the user in an audible (e.g., speech) and/or visual form.

Specifically, a digital assistant is capable of accepting a user request at least partially in the form of a natural language command, request, statement, narrative, and/or inquiry. Typically, the user request seeks either an informational answer or performance of a task by the digital assistant. A satisfactory response to the user request includes a provision of the requested informational answer, a performance of the requested task, or a combination of the two. For example, a user asks the digital assistant a question, such as “Where am I right now?” Based on the user's current location, the digital assistant answers, “You are in Central Park near the west gate.” The user also requests the performance of a task, for example, “Please invite my friends to my girlfriend's birthday party next week.” In response, the digital assistant can acknowledge the request by saying “Yes, right away,” and then send a suitable calendar invite on behalf of the user to each of the user's friends listed in the user's electronic address book. During performance of a requested task, the digital assistant sometimes interacts with the user in a continuous dialogue involving multiple exchanges of information over an extended period of time. There are numerous other ways of interacting with a digital assistant to request information or performance of various tasks. In addition to providing verbal responses and taking programmed actions, the digital assistant also provides responses in other visual or audio forms, e.g., as text, alerts, music, videos, animations, etc.

As shown in FIG. 1, in some examples, a digital assistant is implemented according to a client-server model. The digital assistant includes client-side portion 102 (hereafter “DA client 102”) executed on user device 104 and server-side portion 106 (hereafter “DA server 106”) executed on server system 108. DA client 102 communicates with DA server 106 through one or more networks 110. DA client 102 provides client-side functionalities such as user-facing input and output processing and communication with DA server 106. DA server 106 provides server-side functionalities for any number of DA clients 102 each residing on a respective user device 104.

In some examples, DA server 106 includes client-facing I/O interface 112, one or more processing modules 114, data and models 116, and I/O interface to external services 118. The client-facing I/O interface 112 facilitates the client-facing input and output processing for DA server 106. One or more processing modules 114 utilize data and models 116 to process speech input and determine the user's intent based on natural language input. Further, one or more processing modules 114 perform task execution based on inferred user intent. In some examples, DA server 106 communicates with external services 120 through network(s) 110 for task completion or information acquisition. I/O interface to external services 118 facilitates such communications.

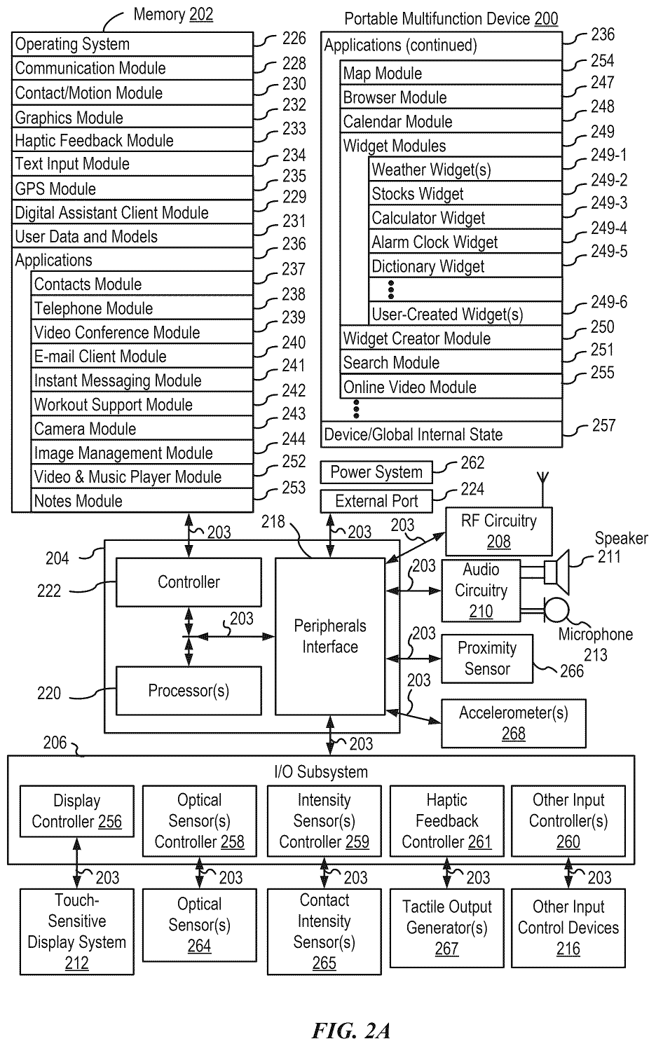

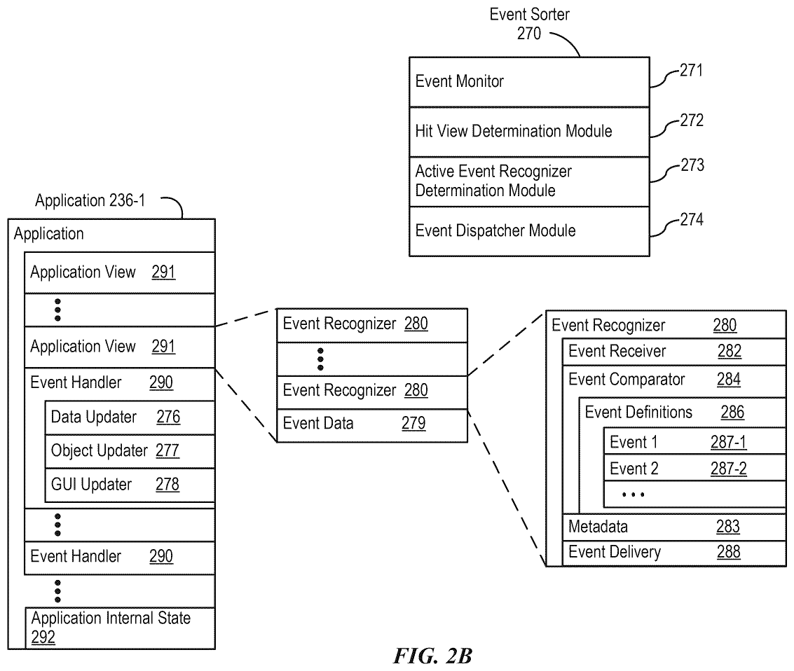

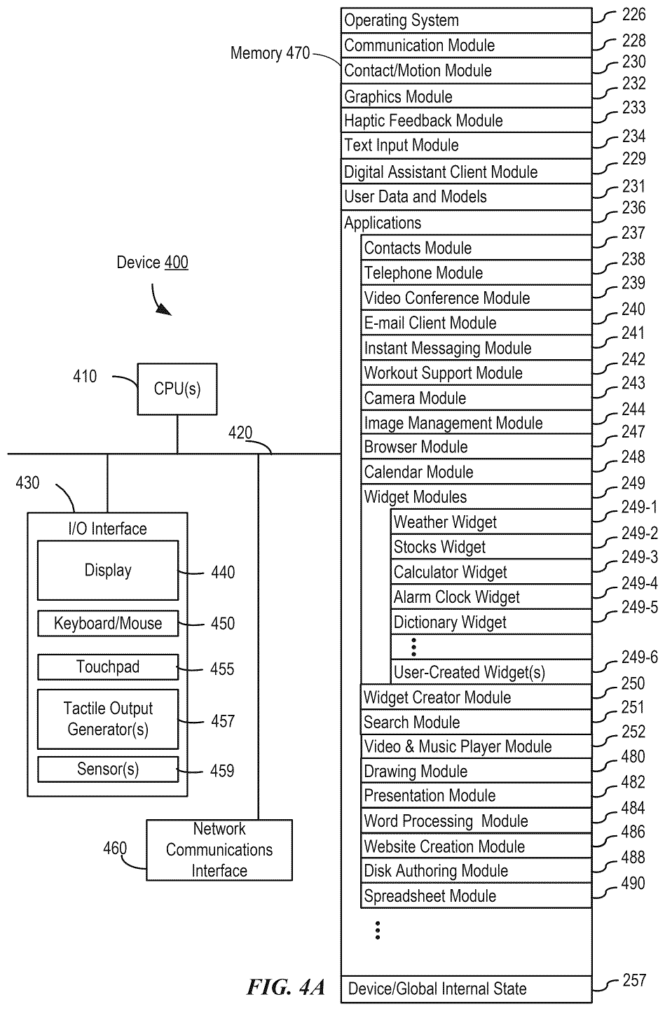

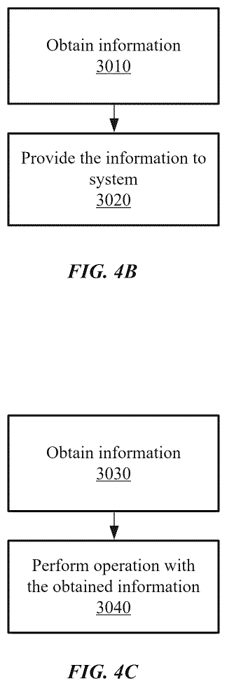

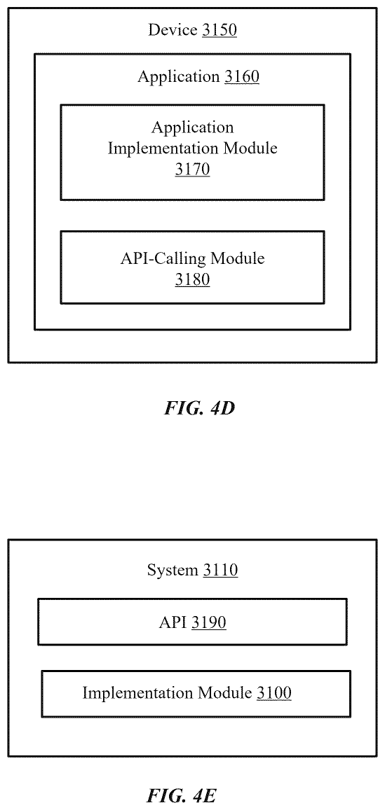

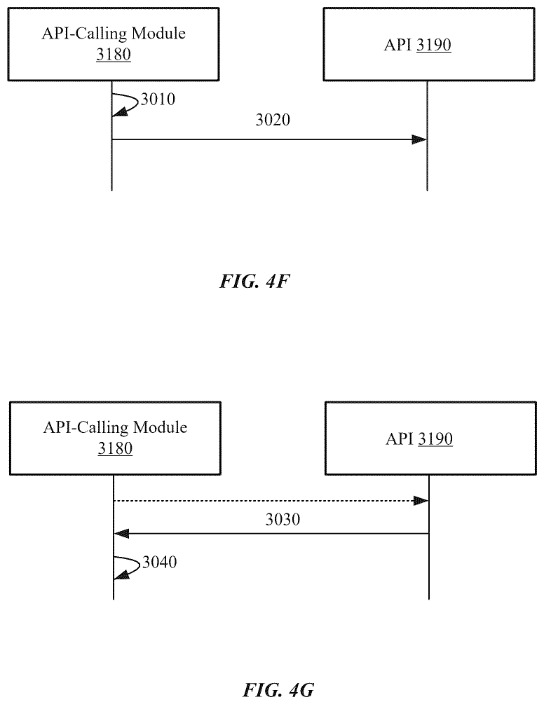

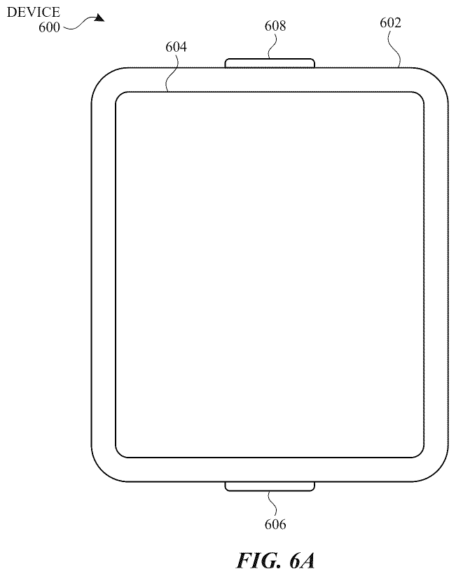

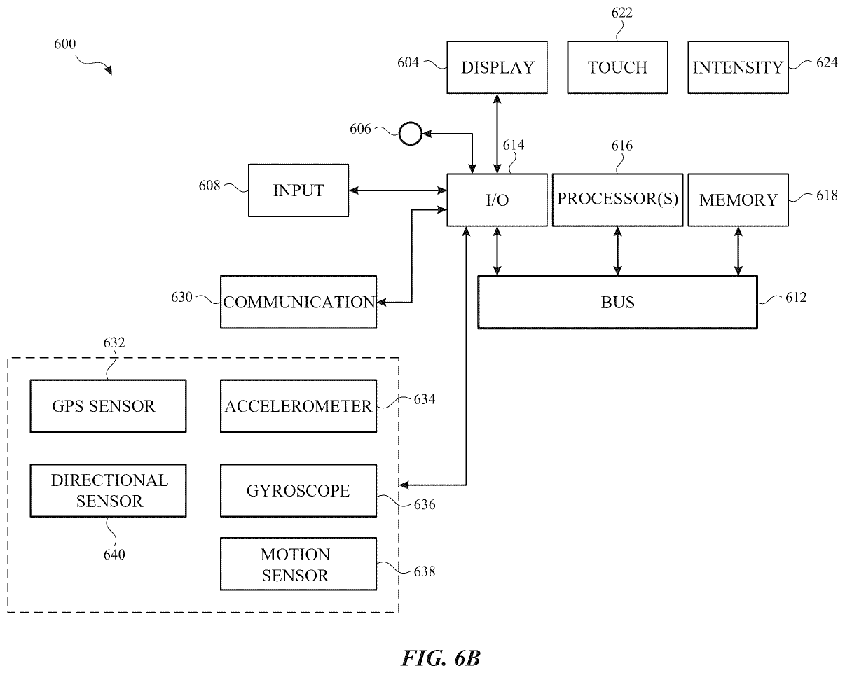

User device 104 can be any suitable electronic device. In some examples, user device 104 is a portable multifunctional device (e.g., device 200, described below with reference to FIG. 2A), a multifunctional device (e.g., device 400, described below with reference to FIG. 4A), or a personal electronic device (e.g., device 600, described below with reference to FIGS. 6A-6B). A portable multifunctional device is, for example, a mobile telephone that also contains other functions, such as PDA and/or music player functions. Specific examples of portable multifunction devices include the Apple Watch®, iPhone®, iPod Touch®, and iPad® devices from Apple Inc. of Cupertino, California. Other examples of portable multifunction devices include, without limitation, earphones/headphones, speakers, and laptop or tablet computers. Further, in some examples, user device 104 is a non-portable multifunctional device. In particular, user device 104 is a desktop computer, a game console, a speaker, a television, or a television set-top box. In some examples, user device 104 includes a touch-sensitive surface (e.g., touch screen displays and/or touchpads). Further, user device 104 optionally includes one or more other physical user-interface devices, such as a physical keyboard, a mouse, and/or a joystick. Various examples of electronic devices, such as multifunctional devices, are described below in greater detail.

Examples of communication network(s) 110 include local area networks (LAN) and wide area networks (WAN), e.g., the Internet. Communication network(s) 110 is implemented using any known network protocol, including various wired or wireless protocols, such as, for example, Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VOIP), Wi-MAX, or any other suitable communication protocol.

Server system 108 is implemented on one or more standalone data processing apparatus or a distributed network of computers. In some examples, server system 108 also employs various virtual devices and/or services of third-party service providers (e.g., third-party cloud service providers) to provide the underlying computing resources and/or infrastructure resources of server system 108.

In some examples, user device 104 communicates with DA server 106 via second user device 122. Second user device 122 is similar or identical to user device 104. For example, second user device 122 is similar to devices 200, 400, or 600 described below with reference to FIGS. 2A, 4A, and 6A-6B. User device 104 is configured to communicatively couple to second user device 122 via a direct communication connection, such as Bluetooth, NFC, BTLE, or the like, or via a wired or wireless network, such as a local Wi-Fi network. In some examples, second user device 122 is configured to act as a proxy between user device 104 and DA server 106. For example, DA client 102 of user device 104 is configured to transmit information (e.g., a user request received at user device 104) to DA server 106 via second user device 122. DA server 106 processes the information and returns relevant data (e.g., data content responsive to the user request) to user device 104 via second user device 122.

In some examples, user device 104 is configured to communicate abbreviated requests for data to second user device 122 to reduce the amount of information transmitted from user device 104. Second user device 122 is configured to determine supplemental information to add to the abbreviated request to generate a complete request to transmit to DA server 106. This system architecture can advantageously allow user device 104 having limited communication capabilities and/or limited battery power (e.g., a watch or a similar compact electronic device) to access services provided by DA server 106 by using second user device 122, having greater communication capabilities and/or battery power (e.g., a mobile phone, laptop computer, tablet computer, or the like), as a proxy to DA server 106. While only two user devices 104 and 122 are shown in FIG. 1, it should be appreciated that system 100, in some examples, includes any number and type of user devices configured in this proxy configuration to communicate with DA server system 106.

Although the digital assistant shown in FIG. 1 includes both a client-side portion (e.g., DA client 102) and a server-side portion (e.g., DA server 106), in some examples, the functions of a digital assistant are implemented as a standalone application installed on a user device. In addition, the divisions of functionalities between the client and server portions of the digital assistant can vary in different implementations. For instance, in some examples, the DA client is a thin-client that provides only user-facing input and output processing functions, and delegates all other functionalities of the digital assistant to a backend server.

### 2. Electronic Devices

Attention is now directed toward embodiments of electronic devices for implementing the client-side portion of a digital assistant. FIG. 2A is a block diagram illustrating portable multifunction device 200 with touch-sensitive display system 212 in accordance with some embodiments. Touch-sensitive display 212 is sometimes called a “touch screen” for convenience and is sometimes known as or called a “touch-sensitive display system.” Device 200 includes memory 202 (which optionally includes one or more computer-readable storage mediums), memory controller 222, one or more processing units (CPUs) 220, peripherals interface 218, RF circuitry 208, audio circuitry 210, speaker 211, microphone 213, input/output (I/O) subsystem 206, other input control devices 216, and external port 224. Device 200 optionally includes one or more optical sensors 264. Device 200 optionally includes one or more contact intensity sensors 265 for detecting intensity of contacts on device 200 (e.g., a touch-sensitive surface such as touch-sensitive display system 212 of device 200). Device 200 optionally includes one or more tactile output generators 267 for generating tactile outputs on device 200 (e.g., generating tactile outputs on a touch-sensitive surface such as touch-sensitive display system 212 of device 200 or touchpad 455 of device 400). These components optionally communicate over one or more communication buses or signal lines 203.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 200 is only one example of a portable multifunction device, and that device 200 optionally has more or fewer components than shown, optionally combines two or more components, or optionally has a different configuration or arrangement of the components. The various components shown in FIG. 2A are implemented in hardware, software, or a combination of both hardware and software, including one or more signal processing and/or application-specific integrated circuits.

Memory 202 includes one or more computer-readable storage mediums. The computer-readable storage mediums are, for example, tangible and non-transitory. Memory 202 includes high-speed random access memory and also includes non-volatile memory, such as one or more magnetic disk storage devices, flash memory devices, or other non-volatile solid-state memory devices. Memory controller 222 controls access to memory 202 by other components of device 200.

In some examples, a non-transitory computer-readable storage medium of memory 202 is used to store instructions (e.g., for performing aspects of processes described below) for use by or in connection with an instruction execution system, apparatus, or device, such as a computer-based system, processor-containing system, or other system that can fetch the instructions from the instruction execution system, apparatus, or device and execute the instructions. In other examples, the instructions (e.g., for performing aspects of the processes described below) are stored on a non-transitory computer-readable storage medium (not shown) of the server system 108 or are divided between the non-transitory computer-readable storage medium of memory 202 and the non-transitory computer-readable storage medium of server system 108.

Peripherals interface 218 is used to couple input and output peripherals of the device to CPU 220 and memory 202. The one or more processors 220 run or execute various software programs and/or sets of instructions stored in memory 202 to perform various functions for device 200 and to process data. In some embodiments, peripherals interface 218, CPU 220, and memory controller 222 are implemented on a single chip, such as chip 204. In some other embodiments, they are implemented on separate chips.

RF (radio frequency) circuitry 208 receives and sends RF signals, also called electromagnetic signals. RF circuitry 208 converts electrical signals to/from electromagnetic signals and communicates with communications networks and other communications devices via the electromagnetic signals. RF circuitry 208 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 208 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 208 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

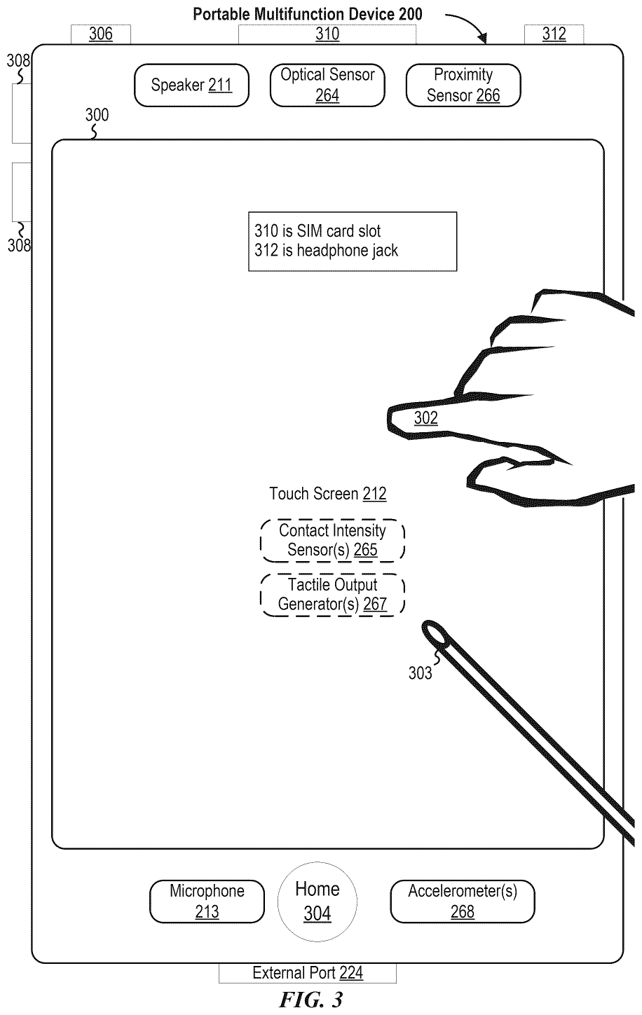

Audio circuitry 210, speaker 211, and microphone 213 provide an audio interface between a user and device 200. Audio circuitry 210 receives audio data from peripherals interface 218, converts the audio data to an electrical signal, and transmits the electrical signal to speaker 211. Speaker 211 converts the electrical signal to human-audible sound waves. Audio circuitry 210 also receives electrical signals converted by microphone 213 from sound waves. Audio circuitry 210 converts the electrical signal to audio data and transmits the audio data to peripherals interface 218 for processing. Audio data are retrieved from and/or transmitted to memory 202 and/or RF circuitry 208 by peripherals interface 218. In some embodiments, audio circuitry 210 also includes a headset jack (e.g., 312, FIG. 3). The headset jack provides an interface between audio circuitry 210 and removable audio input/output peripherals, such as output-only headphones or a headset with both output (e.g., a headphone for one or both ears) and input (e.g., a microphone).

I/O subsystem 206 couples input/output peripherals on device 200, such as touch screen 212 and other input control devices 216, to peripherals interface 218. I/O subsystem 206 optionally includes display controller 256, optical sensor controller 258, intensity sensor controller 259, haptic feedback controller 261, and one or more input controllers 260 for other input or control devices. The one or more input controllers 260 receive/send electrical signals from/to other input control devices 216. The other input control devices 216 optionally include physical buttons (e.g., push buttons, rocker buttons, etc.), dials, slider switches, joysticks, click wheels, and so forth. In some alternate embodiments, input controller(s) 260 are, optionally, coupled to any (or none) of the following: a keyboard, an infrared port, a USB port, and a pointer device such as a mouse. The one or more buttons (e.g., 308, FIG. 3) optionally include an up/down button for volume control of speaker 211 and/or microphone 213. The one or more buttons optionally include a push button (e.g., 306, FIG. 3).

A quick press of the push button disengages a lock of touch screen 212 or begin a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 306) turns power to device 200 on or off. The user is able to customize a functionality of one or more of the buttons. Touch screen 212 is used to implement virtual or soft buttons and one or more soft keyboards.

Touch-sensitive display 212 provides an input interface and an output interface between the device and a user. Display controller 256 receives and/or sends electrical signals from/to touch screen 212. Touch screen 212 displays visual output to the user. The visual output includes graphics, text, icons, video, and any combination thereof (collectively termed “graphics”). In some embodiments, some or all of the visual output correspond to user-interface objects.

Touch screen 212 has a touch-sensitive surface, sensor, or set of sensors that accepts input from the user based on haptic and/or tactile contact. Touch screen 212 and display controller 256 (along with any associated modules and/or sets of instructions in memory 202) detect contact (and any movement or breaking of the contact) on touch screen 212 and convert the detected contact into interaction with user-interface objects (e.g., one or more soft keys, icons, web pages, or images) that are displayed on touch screen 212. In an exemplary embodiment, a point of contact between touch screen 212 and the user corresponds to a finger of the user.

Touch screen 212 uses LCD (liquid crystal display) technology, LPD (light emitting polymer display) technology, or LED (light emitting diode) technology, although other display technologies may be used in other embodiments. Touch screen 212 and display controller 256 detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 212. In an exemplary embodiment, projected mutual capacitance sensing technology is used, such as that found in the iPhone® and iPod Touch® from Apple Inc. of Cupertino, California.

A touch-sensitive display in some embodiments of touch screen 212 is analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 212 displays visual output from device 200, whereas touch-sensitive touchpads do not provide visual output.

A touch-sensitive display in some embodiments of touch screen 212 is as described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 212 has, for example, a video resolution in excess of 100 dpi. In some embodiments, the touch screen has a video resolution of approximately 160 dpi. The user makes contact with touch screen 212 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 200 includes a touchpad (not shown) for activating or deactivating particular functions. In some embodiments, the touchpad is a touch-sensitive area of the device that, unlike the touch screen, does not display visual output. The touchpad is a touch-sensitive surface that is separate from touch screen 212 or an extension of the touch-sensitive surface formed by the touch screen.

Device 200 also includes power system 262 for powering the various components. Power system 262 includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 200 also includes one or more optical sensors 264. FIG. 2A shows an optical sensor coupled to optical sensor controller 258 in I/O subsystem 206. Optical sensor 264 includes charge-coupled device (CCD) or complementary metal-oxide semiconductor (CMOS) phototransistors. Optical sensor 264 receives light from the environment, projected through one or more lenses, and converts the light to data representing an image. In conjunction with imaging module 243 (also called a camera module), optical sensor 264 captures still images or video. In some embodiments, an optical sensor is located on the back of device 200, opposite touch screen display 212 on the front of the device so that the touch screen display is used as a viewfinder for still and/or video image acquisition. In some embodiments, an optical sensor is located on the front of the device so that the user's image is obtained for video conferencing while the user views the other video conference participants on the touch screen display. In some embodiments, the position of optical sensor 264 can be changed by the user (e.g., by rotating the lens and the sensor in the device housing) so that a single optical sensor 264 is used along with the touch screen display for both video conferencing and still and/or video image acquisition.

Device 200 optionally also includes one or more contact intensity sensors 265. FIG. 2A shows a contact intensity sensor coupled to intensity sensor controller 259 in I/O subsystem 206. Contact intensity sensor 265 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 265 receives contact intensity information (e.g., pressure information or a proxy for pressure information) from the environment. In some embodiments, at least one contact intensity sensor is collocated with, or proximate to, a touch-sensitive surface (e.g., touch-sensitive display system 212). In some embodiments, at least one contact intensity sensor is located on the back of device 200, opposite touch screen display 212, which is located on the front of device 200.

Device 200 also includes one or more proximity sensors 266. FIG. 2A shows proximity sensor 266 coupled to peripherals interface 218. Alternately, proximity sensor 266 is coupled to input controller 260 in I/O subsystem 206. Proximity sensor 266 is performed as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 212 when the multifunction device is placed near the user's ear (e.g., when the user is making a phone call).

Device 200 optionally also includes one or more tactile output generators 267. FIG. 2A shows a tactile output generator coupled to haptic feedback controller 261 in I/O subsystem 206. Tactile output generator 267 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 265 receives tactile feedback generation instructions from haptic feedback module 233 and generates tactile outputs on device 200 that are capable of being sensed by a user of device 200. In some embodiments, at least one tactile output generator is collocated with, or proximate to, a touch-sensitive surface (e.g., touch-sensitive display system 212) and, optionally, generates a tactile output by moving the touch-sensitive surface vertically (e.g., in/out of a surface of device 200) or laterally (e.g., back and forth in the same plane as a surface of device 200). In some embodiments, at least one tactile output generator sensor is located on the back of device 200, opposite touch screen display 212, which is located on the front of device 200.

Device 200 also includes one or more accelerometers 268. FIG. 2A shows accelerometer 268 coupled to peripherals interface 218. Alternately, accelerometer 268 is coupled to an input controller 260 in I/O subsystem 206. Accelerometer 268 performs, for example, as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 200 optionally includes, in addition to accelerometer(s) 268, a magnetometer (not shown) and a GPS (or GLONASS or other global navigation system) receiver (not shown) for obtaining information concerning the location and orientation (e.g., portrait or landscape) of device 200.

In some embodiments, the software components stored in memory 202 include operating system 226, communication module (or set of instructions) 228, contact/motion module (or set of instructions) 230, graphics module (or set of instructions) 232, text input module (or set of instructions) 234, Global Positioning System (GPS) module (or set of instructions) 235, Digital Assistant Client Module 229, and applications (or sets of instructions) 236. Further, memory 202 stores data and models, such as user data and models 231. Furthermore, in some embodiments, memory 202 (FIG. 2A) or 470 (FIG. 4A) stores device/global internal state 257, as shown in FIGS. 2A and 4A. Device/global internal state 257 includes one or more of: active application state, indicating which applications, if any, are currently active; display state, indicating what applications, views or other information occupy various regions of touch screen display 212; sensor state, including information obtained from the device's various sensors and input control devices 216; and location information concerning the device's location and/or attitude.

Operating system 226 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 228 facilitates communication with other devices over one or more external ports 224 and also includes various software components for handling data received by RF circuitry 208 and/or external port 224. External port 224 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 230 optionally detects contact with touch screen 212 (in conjunction with display controller 256) and other touch-sensitive devices (e.g., a touchpad or physical click wheel). Contact/motion module 230 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 230 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 230 and display controller 256 detect contact on a touchpad.

In some embodiments, contact/motion module 230 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 200). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 230 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 232 includes various known software components for rendering and displaying graphics on touch screen 212 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 232 stores data representing graphics to be used. Each graphic is, optionally, assigned a corresponding code. Graphics module 232 receives, from applications etc., one or more codes specifying graphics to be displayed along with, if necessary, coordinate data and other graphic property data, and then generates screen image data to output to display controller 256.

Haptic feedback module 233 includes various software components for generating instructions used by tactile output generator(s) 267 to produce tactile outputs at one or more locations on device 200 in response to user interactions with device 200.

Text input module 234, which is, in some examples, a component of graphics module 232, provides soft keyboards for entering text in various applications (e.g., contacts module 237, email client module 240, instant messaging (IM) module 241, browser module 247, and any other application that needs text input).

GPS module 235 determines the location of the device and provides this information for use in various applications (e.g., to telephone module 238 for use in location-based dialing; to camera module 243 as picture/video metadata; and to applications that provide location-based services such as weather widgets, local yellow page widgets, and map/navigation widgets).

Digital assistant client module 229 includes various client-side digital assistant instructions to provide the client-side functionalities of the digital assistant. For example, digital assistant client module 229 is capable of accepting voice input (e.g., speech input), text input, touch input, and/or gestural input through various user interfaces (e.g., microphone 213, accelerometer(s) 268, touch-sensitive display system 212, optical sensor(s) 264, other input control devices 216, etc.) of portable multifunction device 200. Digital assistant client module 229 is also capable of providing output in audio (e.g., speech output), visual, and/or tactile forms through various output interfaces (e.g., speaker 211, touch-sensitive display system 212, tactile output generator(s) 267, etc.) of portable multifunction device 200. For example, output is provided as voice, sound, alerts, text messages, menus, graphics, videos, animations, vibrations, and/or combinations of two or more of the above. During operation, digital assistant client module 229 communicates with DA server 106 using RF circuitry 208.

User data and models 231 include various data associated with the user (e.g., user-specific vocabulary data, user preference data, user-specified name pronunciations, data from the user's electronic address book, to-do lists, shopping lists, etc.) to provide the client-side functionalities of the digital assistant. Further, user data and models 231 include various models (e.g., speech recognition models, statistical language models, natural language processing models, ontology, task flow models, service models, etc.) for processing user input and determining user intent.

In some examples, digital assistant client module 229 utilizes the various sensors, subsystems, and peripheral devices of portable multifunction device 200 to gather additional information from the surrounding environment of the portable multifunction device 200 to establish a context associated with a user, the current user interaction, and/or the current user input. In some examples, digital assistant client module 229 provides the contextual information or a subset thereof with the user input to DA server 106 to help infer the user's intent. In some examples, the digital assistant also uses the contextual information to determine how to prepare and deliver outputs to the user. Contextual information is referred to as context data.

In some examples, the contextual information that accompanies the user input includes sensor information, e.g., lighting, ambient noise, ambient temperature, images or videos of the surrounding environment, etc. In some examples, the contextual information can also include the physical state of the device, e.g., device orientation, device location, device temperature, power level, speed, acceleration, motion patterns, cellular signals strength, etc. In some examples, information related to the software state of DA server 106, e.g., running processes, installed programs, past and present network activities, background services, error logs, resources usage, etc., and of portable multifunction device 200 is provided to DA server 106 as contextual information associated with a user input.

In some examples, the digital assistant client module 229 selectively provides information (e.g., user data 231) stored on the portable multifunction device 200 in response to requests from DA server 106. In some examples, digital assistant client module 229 also elicits additional input from the user via a natural language dialogue or other user interfaces upon request by DA server 106. Digital assistant client module 229 passes the additional input to DA server 106 to help DA server 106 in intent deduction and/or fulfillment of the user's intent expressed in the user request.

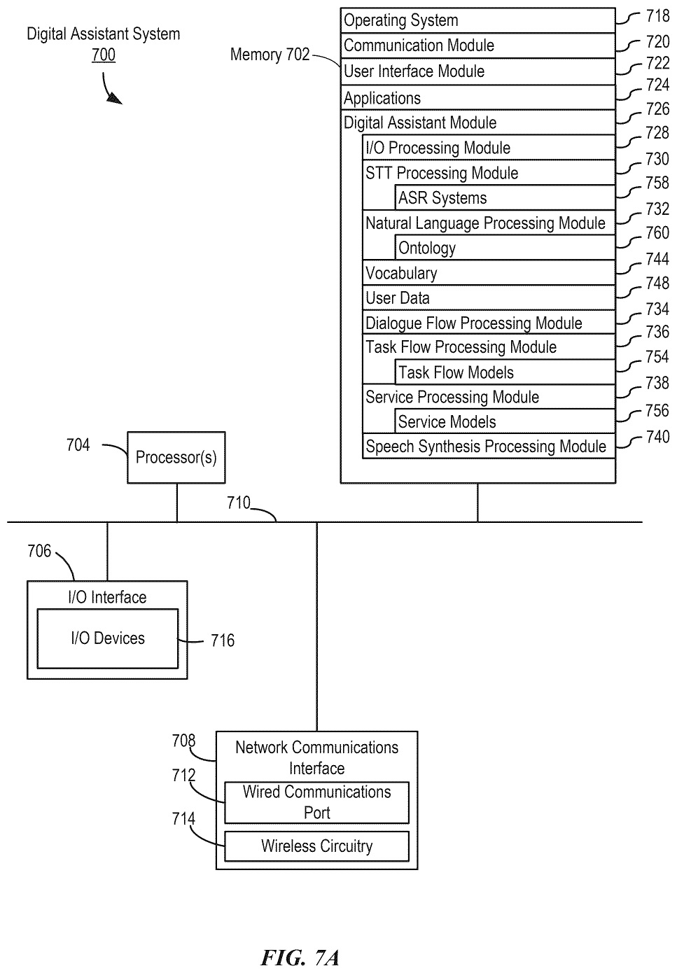

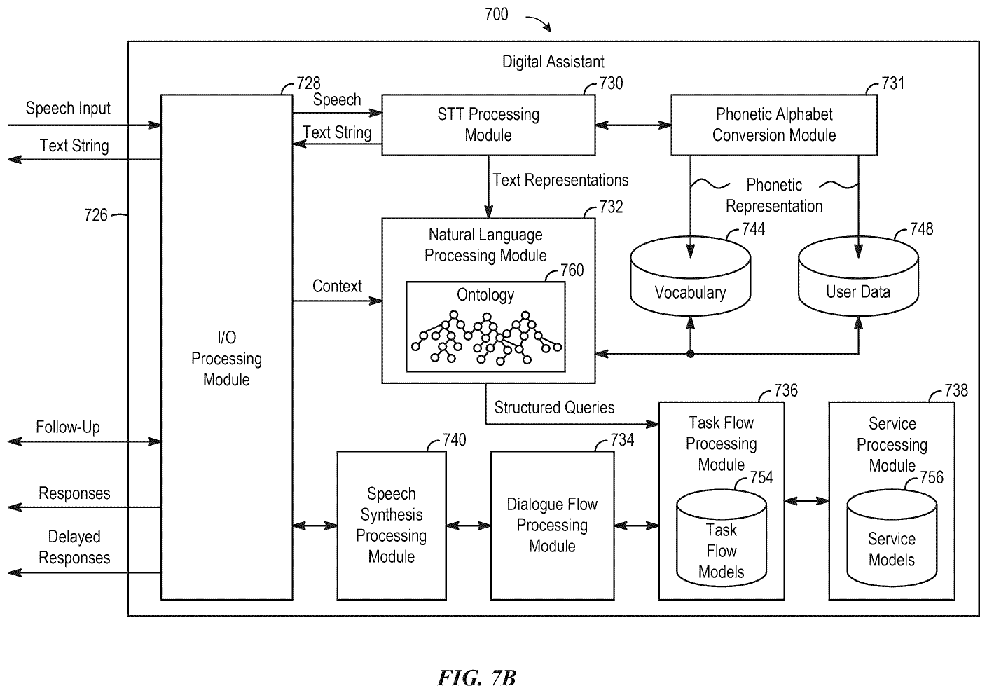

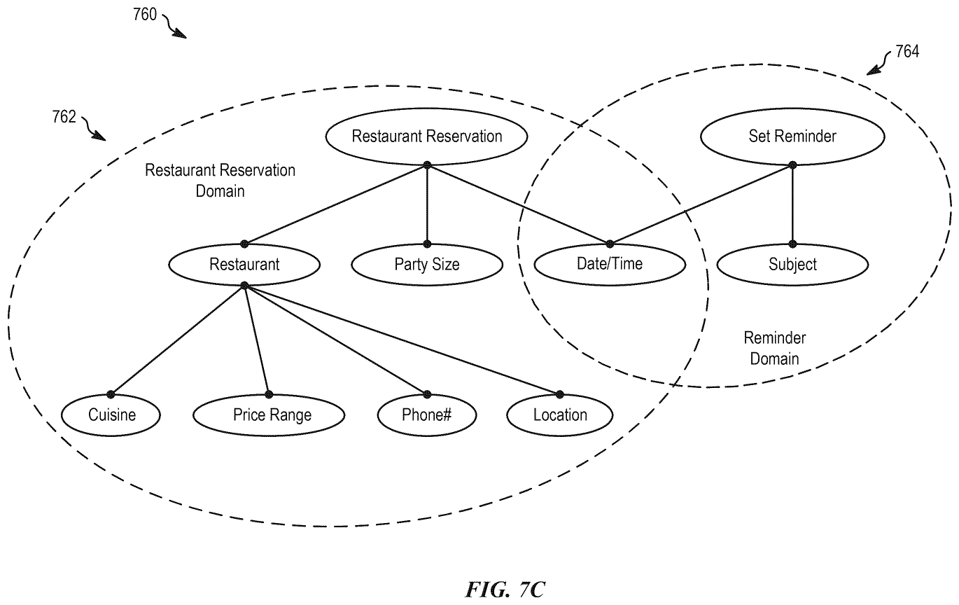

A more detailed description of a digital assistant is described below with reference to FIGS. 7A-7C. It should be recognized that digital assistant client module 229 can include any number of the sub-modules of digital assistant module 726 described below.

Applications 236 include the following modules (or sets of instructions), or a subset or superset thereof:
Contacts module 237 (sometimes called an address book or contact list);
Telephone module 238;
Video conference module 239;
E-mail client module 240;
Instant messaging (IM) module 241;
Workout support module 242;
Camera module 243 for still and/or video images;
Image management module 244;
Video player module;
Music player module;
Browser module 247;
Calendar module 248;
Widget modules 249, which includes, in some examples, one or more of: weather widget 249-1, stocks widget 249-2, calculator widget 249-3, alarm clock widget 249-4, dictionary widget 249-5, and other widgets obtained by the user, as well as user-created widgets 249-6;
Widget creator module 250 for making user-created widgets 249-6;
Search module 251;
Video and music player module 252, which merges video player module and music player module;
Notes module 253;
Map module 254; and/or
Online video module 255.

Examples of other applications 236 that are stored in memory 202 include other word processing applications, other image editing applications, drawing applications, presentation applications, JAVA-enabled applications, encryption, digital rights management, voice recognition, and voice replication.

In conjunction with touch screen 212, display controller 256, contact/motion module 230, graphics module 232, and text input module 234, contacts module 237 are used to manage an address book or contact list (e.g., stored in application internal state 292 of contacts module 237 in memory 202 or memory 470), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 238, video conference module 239, e-mail client module 240, or IM module 241; and so forth.

In conjunction with RF circuitry 208, audio circuitry 210, speaker 211, microphone 213, touch screen 212, display controller 256, contact/motion module 230, graphics module 232, and text input module 234, telephone module 238 are used to enter a sequence of characters corresponding to a telephone number, access one or more telephone numbers in contacts module 237, modify a telephone number that has been entered, dial a respective telephone number, conduct a conversation, and disconnect or hang up when the conversation is completed. As noted above, the wireless communication uses any of a plurality of communications standards, protocols, and technologies.

In conjunction with RF circuitry 208, audio circuitry 210, speaker 211, microphone 213, touch screen 212, display controller 256, optical sensor 264, optical sensor controller 258, contact/motion module 230, graphics module 232, text input module 234, contacts module 237, and telephone module 238, video conference module 239 includes executable instructions to initiate, conduct, and terminate a video conference between a user and one or more other participants in accordance with user instructions.

In conjunction with RF circuitry 208, touch screen 212, display controller 256, contact/motion module 230, graphics module 232, and text input module 234, e-mail client module 240 includes executable instructions to create, send, receive, and manage e-mail in response to user instructions. In conjunction with image management module 244, e-mail client module 240 makes it very easy to create and send e-mails with still or video images taken with camera module 243.

In conjunction with RF circuitry 208, touch screen 212, display controller 256, contact/motion module 230, graphics module 232, and text input module 234, the instant messaging module 241 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 208, touch screen 212, display controller 256, contact/motion module 230, graphics module 232, text input module 234, GPS module 235, map module 254, and music player module, workout support module 242 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 212, display controller 256, optical sensor(s) 264, optical sensor controller 258, contact/motion module 230, graphics module 232, and image management module 244, camera module 243 includes executable instructions to capture still images or video (including a video stream) and store them into memory 202, modify characteristics of a still image or video, or delete a still image or video from memory 202.

In conjunction with touch screen 212, display controller 256, contact/motion module 230, graphics module 232, text input module 234, and camera module 243, image management module 244 includes executable instructions to arrange, modify (e.g., edit), or otherwise manipulate, label, delete, present (e.g., in a digital slide show or album), and store still and/or video images.

In conjunction with RF circuitry 208, touch screen 212, display controller 256, contact/motion module 230, graphics module 232, and text input module 234, browser module 247 includes executable instructions to browse the Internet in accordance with user instructions, including searching, linking to, receiving, and displaying web pages or portions thereof, as well as attachments and other files linked to web pages.

In conjunction with RF circuitry 208, touch screen 212, display controller 256, contact/motion module 230, graphics module 232, text input module 234, e-mail client module 240, and browser module 247, calendar module 248 includes executable instructions to create, display, modify, and store calendars and data associated with calendars (e.g., calendar entries, to-do lists, etc.) in accordance with user instructions.

In conjunction with RF circuitry 208, touch screen 212, display controller 256, contact/motion module 230, graphics module 232, text input module 234, and browser module 247, widget modules 249 are mini-applications that can be downloaded and used by a user (e.g., weather widget 249-1, stocks widget 249-2, calculator widget 249-3, alarm clock widget 249-4, and dictionary widget 249-5) or created by the user (e.g., user-created widget 249-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 208, touch screen 212, display controller 256, contact/motion module 230, graphics module 232, text input module 234, and browser module 247, the widget creator module 250 are used by a user to create widgets (e.g., turning a user-specified portion of a web page into a widget).

In conjunction with touch screen 212, display controller 256, contact/motion module 230, graphics module 232, and text input module 234, search module 251 includes executable instructions to search for text, music, sound, image, video, and/or other files in memory 202 that match one or more search criteria (e.g., one or more user-specified search terms) in accordance with user instructions.

In conjunction with touch screen 212, display controller 256, contact/motion module 230, graphics module 232, audio circuitry 210, speaker 211, RF circuitry 208, and browser module 247, video and music player module 252 includes executable instructions that allow the user to download and play back recorded music and other sound files stored in one or more file formats, such as MP3 or AAC files, and executable instructions to display, present, or otherwise play back videos (e.g., on touch screen 212 or on an external, connected display via external port 224). In some embodiments, device 200 optionally includes the functionality of an MP3 player, such as an iPod (trademark of Apple Inc.).

In conjunction with touch screen 212, display controller 256, contact/motion module 230, graphics module 232, and text input module 234, notes module 253 includes executable instructions to create and manage notes, to-do lists, and the like in accordance with user instructions.

In conjunction with RF circuitry 208, touch screen 212, display controller 256, contact/motion module 230, graphics module 232, text input module 234, GPS module 235, and browser module 247, map module 254 are used to receive, display, modify, and store maps and data associated with maps (e.g., driving directions, data on stores and other points of interest at or near a particular location, and other location-based data) in accordance with user instructions.

In conjunction with touch screen 212, display controller 256, contact/motion module 230, graphics module 232, audio circuitry 210, speaker 211, RF circuitry 208, text input module 234, e-mail client module 240, and browser module 247, online video module 255 includes instructions that allow the user to access, browse, receive (e.g., by streaming and/or download), play back (e.g., on the touch screen or on an external, connected display via external port 224), send an e-mail with a link to a particular online video, and otherwise manage online videos in one or more file formats, such as H.264. In some embodiments, instant messaging module 241, rather than e-mail client module 240, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules can be combined or otherwise rearranged in various embodiments. For example, video player module can be combined with music player module into a single module (e.g., video and music player module 252, FIG. 2A). In some embodiments, memory 202 stores a subset of the modules and data structures identified above. Furthermore, memory 202 stores additional modules and data structures not described above.

In some embodiments, device 200 is a device where operation of a predefined set of functions on the device is performed exclusively through a touch screen and/or a touchpad. By using a touch screen and/or a touchpad as the primary input control device for operation of device 200, the number of physical input control devices (such as push buttons, dials, and the like) on device 200 is reduced.

The predefined set of functions that are performed exclusively through a touch screen and/or a touchpad optionally include navigation between user interfaces. In some embodiments, the touchpad, when touched by the user, navigates device 200 to a main, home, or root menu from any user interface that is displayed on device 200. In such embodiments, a “menu button” is implemented using a touchpad. In some other embodiments, the menu button is a physical push button or other physical input control device instead of a touchpad.

FIG. 2B is a block diagram illustrating exemplary components for event handling in accordance with some embodiments. In some embodiments, memory 202 (FIG. 2A) or 470 (FIG. 4A) includes event sorter 270 (e.g., in operating system 226) and a respective application 236-1 (e.g., any of the aforementioned applications 237-251, 255, 480-490).

Event sorter 270 receives event information and determines the application 236-1 and application view 291 of application 236-1 to which to deliver the event information. Event sorter 270 includes event monitor 271 and event dispatcher module 274. In some embodiments, application 236-1 includes application internal state 292, which indicates the current application view(s) displayed on touch-sensitive display 212 when the application is active or executing. In some embodiments, device/global internal state 257 is used by event sorter 270 to determine which application(s) is (are) currently active, and application internal state 292 is used by event sorter 270 to determine application views 291 to which to deliver event information.

In some embodiments, application internal state 292 includes additional information, such as one or more of: resume information to be used when application 236-1 resumes execution, user interface state information that indicates information being displayed or that is ready for display by application 236-1, a state queue for enabling the user to go back to a prior state or view of application 236-1, and a redo/undo queue of previous actions taken by the user.

Event monitor 271 receives event information from peripherals interface 218. Event information includes information about a sub-event (e.g., a user touch on touch-sensitive display 212, as part of a multi-touch gesture). Peripherals interface 218 transmits information it receives from I/O subsystem 206 or a sensor, such as proximity sensor 266, accelerometer(s) 268, and/or microphone 213 (through audio circuitry 210). Information that peripherals interface 218 receives from I/O subsystem 206 includes information from touch-sensitive display 212 or a touch-sensitive surface.

In some embodiments, event monitor 271 sends requests to the peripherals interface 218 at predetermined intervals. In response, peripherals interface 218 transmits event information. In other embodiments, peripherals interface 218 transmits event information only when there is a significant event (e.g., receiving an input above a predetermined noise threshold and/or for more than a predetermined duration).

In some embodiments, event sorter 270 also includes a hit view determination module 272 and/or an active event recognizer determination module 273.

Hit view determination module 272 provides software procedures for determining where a sub-event has taken place within one or more views when touch-sensitive display 212 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected correspond to programmatic levels within a programmatic or view hierarchy of the application. For example, the lowest level view in which a touch is detected is called the hit view, and the set of events that are recognized as proper inputs is determined based, at least in part, on the hit view of the initial touch that begins a touch-based gesture.

Hit view determination module 272 receives information related to sub events of a touch-based gesture. When an application has multiple views organized in a hierarchy, hit view determination module 272 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 272, the hit view typically receives all sub-events related to the same touch or input source for which it was identified as the hit view.

Active event recognizer determination module 273 determines which view or views within a view hierarchy should receive a particular sequence of sub-events. In some embodiments, active event recognizer determination module 273 determines that only the hit view should receive a particular sequence of sub-events. In other embodiments, active event recognizer determination module 273 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 274 dispatches the event information to an event recognizer (e.g., event recognizer 280). In embodiments including active event recognizer determination module 273, event dispatcher module 274 delivers the event information to an event recognizer determined by active event recognizer determination module 273. In some embodiments, event dispatcher module 274 stores in an event queue the event information, which is retrieved by a respective event receiver 282.

In some embodiments, operating system 226 includes event sorter 270. Alternatively, application 236-1 includes event sorter 270. In yet other embodiments, event sorter 270 is a stand-alone module, or a part of another module stored in memory 202, such as contact/motion module 230.

In some embodiments, application 236-1 includes a plurality of event handlers 290 and one or more application views 291, each of which includes instructions for handling touch events that occur within a respective view of the application's user interface. Each application view 291 of the application 236-1 includes one or more event recognizers 280. Typically, a respective application view 291 includes a plurality of event recognizers 280. In other embodiments, one or more of event recognizers 280 are part of a separate module, such as a user interface kit (not shown) or a higher level object from which application 236-1 inherits methods and other properties. In some embodiments, a respective event handler 290 includes one or more of: data updater 276, object updater 277, GUI updater 278, and/or event data 279 received from event sorter 270. Event handler 290 utilizes or calls data updater 276, object updater 277, or GUI updater 278 to update the application internal state 292. Alternatively, one or more of the application views 291 include one or more respective event handlers 290. Also, in some embodiments, one or more of data updater 276, object updater 277, and GUI updater 278 are included in a respective application view 291.

A respective event recognizer 280 receives event information (e.g., event data 279) from event sorter 270 and identifies an event from the event information. Event recognizer 280 includes event receiver 282 and event comparator 284. In some embodiments, event recognizer 280 also includes at least a subset of: metadata 283, and event delivery instructions 288 (which include sub-event delivery instructions).

Event receiver 282 receives event information from event sorter 270. The event information includes information about a sub-event, for example, a touch or a touch movement. Depending on the sub-event, the event information also includes additional information, such as location of the sub-event. When the sub-event concerns motion of a touch, the event information also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 284 compares the event information to predefined event or sub-event definitions and, based on the comparison, determines an event or sub event, or determines or updates the state of an event or sub-event. In some embodiments, event comparator 284 includes event definitions 286. Event definitions 286 contain definitions of events (e.g., predefined sequences of sub-events), for example, event 1 (287-1), event 2 (287-2), and others. In some embodiments, sub-events in an event (287) include, for example, touch begin, touch end, touch movement, touch cancellation, and multiple touching. In one example, the definition for event 1 (287-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (287-2) is a dragging on a displayed object. The dragging, for example, comprises a touch (or contact) on the displayed object for a predetermined phase, a movement of the touch across touch-sensitive display 212, and liftoff of the touch (touch end). In some embodiments, the event also includes information for one or more associated event handlers 290.

In some embodiments, event definition 287 includes a definition of an event for a respective user-interface object. In some embodiments, event comparator 284 performs a hit test to determine which user-interface object is associated with a sub-event. For example, in an application view in which three user-interface objects are displayed on touch-sensitive display 212, when a touch is detected on touch-sensitive display 212, event comparator 284 performs a hit test to determine which of the three user-interface objects is associated with the touch (sub-event). If each displayed object is associated with a respective event handler 290, the event comparator uses the result of the hit test to determine which event handler 290 should be activated. For example, event comparator 284 selects an event handler associated with the sub-event and the object triggering the hit test.

In some embodiments, the definition for a respective event (287) also includes delayed actions that delay delivery of the event information until after it has been determined whether the sequence of sub-events does or does not correspond to the event recognizer's event type.

When a respective event recognizer 280 determines that the series of sub-events do not match any of the events in event definitions 286, the respective event recognizer 280 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 280 includes metadata 283 with configurable properties, flags, and/or lists that indicate how the event delivery system should perform sub-event delivery to actively involved event recognizers. In some embodiments, metadata 283 includes configurable properties, flags, and/or lists that indicate how event recognizers interact, or are enabled to interact, with one another. In some embodiments, metadata 283 includes configurable properties, flags, and/or lists that indicate whether sub-events are delivered to varying levels in the view or programmatic hierarchy.

In some embodiments, a respective event recognizer 280 activates event handler 290 associated with an event when one or more particular sub-events of an event are recognized. In some embodiments, a respective event recognizer 280 delivers event information associated with the event to event handler 290. Activating an event handler 290 is distinct from sending (and deferred sending) sub-events to a respective hit view. In some embodiments, event recognizer 280 throws a flag associated with the recognized event, and event handler 290 associated with the flag catches the flag and performs a predefined process.

In some embodiments, event delivery instructions 288 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 276 creates and updates data used in application 236-1. For example, data updater 276 updates the telephone number used in contacts module 237, or stores a video file used in video player module. In some embodiments, object updater 277 creates and updates objects used in application 236-1. For example, object updater 277 creates a new user-interface object or updates the position of a user-interface object. GUI updater 278 updates the GUI. For example, GUI updater 278 prepares display information and sends it to graphics module 232 for display on a touch-sensitive display.

In some embodiments, event handler(s) 290 includes or has access to data updater 276, object updater 277, and GUI updater 278. In some embodiments, data updater 276, object updater 277, and GUI updater 278 are included in a single module of a respective application 236-1 or application view 291. In other embodiments, they are included in two or more software modules.

It shall be understood that the foregoing discussion regarding event handling of user touches on touch-sensitive displays also applies to other forms of user inputs to operate multifunction devices 200 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 3 illustrates a portable multifunction device 200 having a touch screen 212 in accordance with some embodiments. The touch screen optionally displays one or more graphics within user interface (UI) 300. In this embodiment, as well as others described below, a user is enabled to select one or more of the graphics by making a gesture on the graphics, for example, with one or more fingers 302 (not drawn to scale in the figure) or one or more styluses 303 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 200. In some implementations or circumstances, inadvertent contact with a graphic does not select the graphic. For example, a swipe gesture that sweeps over an application icon optionally does not select the corresponding application when the gesture corresponding to selection is a tap.

Device 200 also includes one or more physical buttons, such as “home” or menu button 304. As described previously, menu button 304 is used to navigate to any application 236 in a set of applications that is executed on device 200. Alternatively, in some embodiments, the menu button is implemented as a soft key in a GUI displayed on touch screen 212.

In one embodiment, device 200 includes touch screen 212, menu button 304, push button 306 for powering the device on/off and locking the device, volume adjustment button(s) 308, subscriber identity module (SIM) card slot 310, headset jack 312, and docking/charging external port 224. Push button 306 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 200 also accepts verbal input for activation or deactivation of some functions through microphone 213. Device 200 also, optionally, includes one or more contact intensity sensors 265 for detecting intensity of contacts on touch screen 212 and/or one or more tactile output generators 267 for generating tactile outputs for a user of device 200.

FIG. 4A is a block diagram of an exemplary multifunction device with a display and a touch-sensitive surface in accordance with some embodiments. Device 400 need not be portable. In some embodiments, device 400 is a laptop computer, a desktop computer, a tablet computer, a multimedia player device, a navigation device, an educational device (such as a child's learning toy), a gaming system, or a control device (e.g., a home or industrial controller). Device 400 typically includes one or more processing units (CPUs) 410, one or more network or other communications interfaces 460, memory 470, and one or more communication buses 420 for interconnecting these components. Communication buses 420 optionally include circuitry (sometimes called a chipset) that interconnects and controls communications between system components. Device 400 includes input/output (I/O) interface 430 comprising display 440, which is typically a touch screen display. I/O interface 430 also optionally includes a keyboard and/or mouse (or other pointing device) 450 and touchpad 455, tactile output generator 457 for generating tactile outputs on device 400 (e.g., similar to tactile output generator(s) 267 described above with reference to FIG. 2A), sensors 459 (e.g., optical, acceleration, proximity, touch-sensitive, and/or contact intensity sensors similar to contact intensity sensor(s) 265 described above with reference to FIG. 2A). Memory 470 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 470 optionally includes one or more storage devices remotely located from CPU(s) 410. In some embodiments, memory 470 stores programs, modules, and data structures analogous to the programs, modules, and data structures stored in memory 202 of portable multifunction device 200 (FIG. 2A), or a subset thereof. Furthermore, memory 470 optionally stores additional programs, modules, and data structures not present in memory 202 of portable multifunction device 200. For example, memory 470 of device 400 optionally stores drawing module 480, presentation module 482, word processing module 484, website creation module 486, disk authoring module 488, and/or spreadsheet module 490, while memory 202 of portable multifunction device 200 (FIG. 2A) optionally does not store these modules.

Each of the above-identified elements in FIG. 4A is, in some examples, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are combined or otherwise rearranged in various embodiments. In some embodiments, memory 470 stores a subset of the modules and data structures identified above. Furthermore, memory 470 stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 4B, the method of FIG. 4C, and/or one or more other processes and/or methods described herein.

It should be recognized that application 3160 (shown in FIG. 4D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 4B and FIG. 4F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 4E) is an operating system hosted on device 3150. In some embodiments, the system (e.g., 3110 shown in FIG. 4E) is an external device (e.g., a server, a peripheral device, an accessory, and/or a personal computing device) that includes an operating system.

Referring to FIG. 4C and FIG. 4G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 4B and/or the method of FIG. 4C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 4B and/or the method of FIG. 4C by calling an application programming interface (API) (e.g., API 3190) provided by system 3110. In some embodiments, application 3160 performs at least a portion of the method of FIG. 4B and/or the method of FIG. 4C without calling API 3190.

In some embodiments, one or more steps of the method of FIG. 4B and/or the method of FIG. 4C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 4D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 4D, device 3150 includes application 3160 and an operating system (e.g., system 3110 shown in FIG. 4E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 4D and 4E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 4E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 1100 and/or 1200 (FIGS. 11 and/or 12A-12B) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that can be implemented on, for example, portable multifunction device 200.

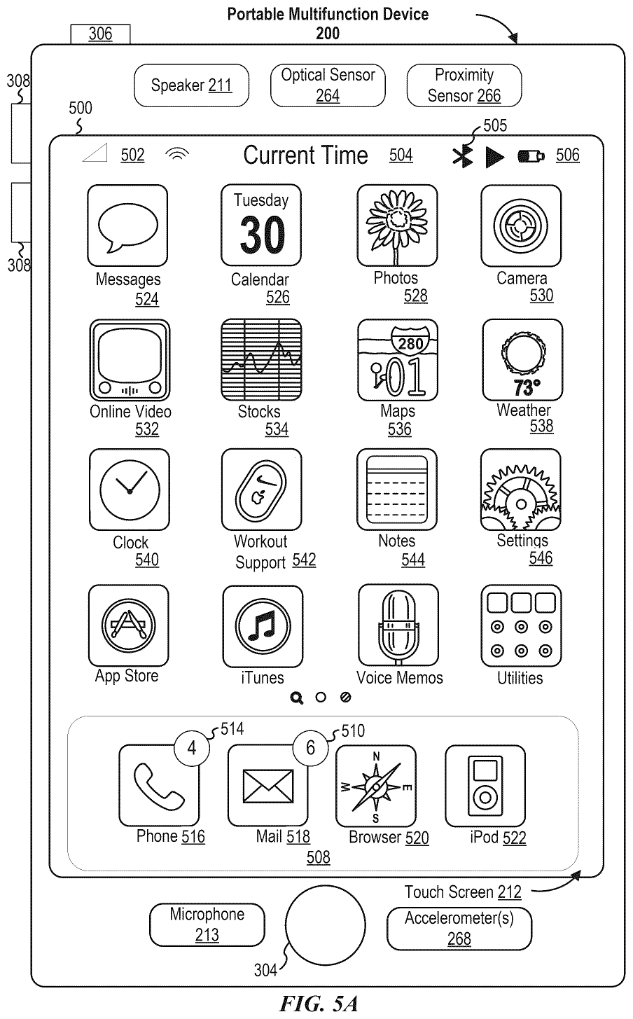

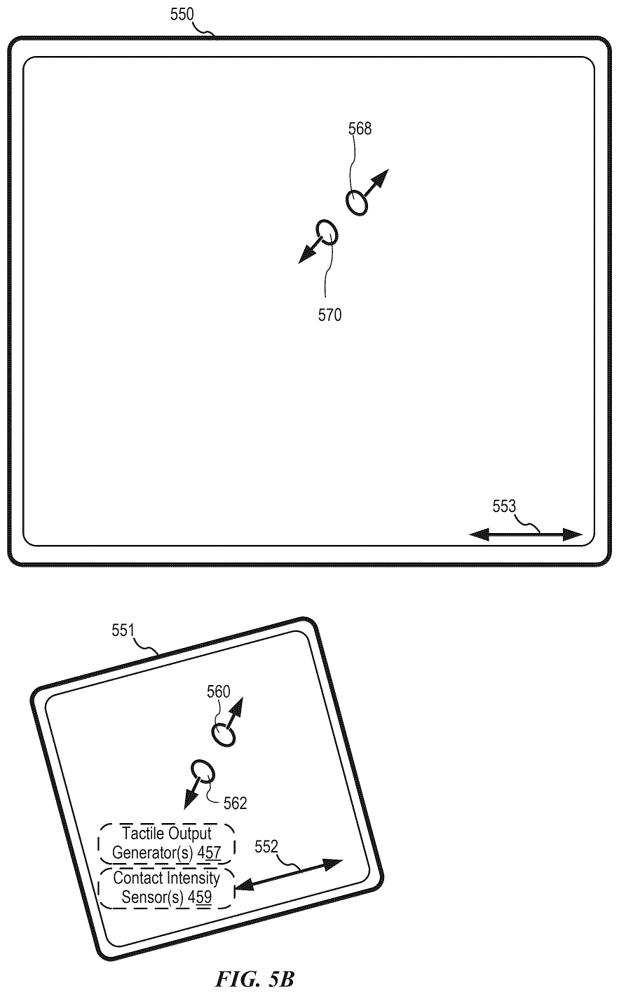

FIG. 5A illustrates an exemplary user interface for a menu of applications on portable multifunction device 200 in accordance with some embodiments. Similar user interfaces are implemented on device 400. In some embodiments, user interface 500 includes the following elements, or a subset or superset thereof:

Signal strength indicator(s) 502 for wireless communication(s), such as cellular and Wi-Fi signals;
Time 504;
Bluetooth indicator 505;
Battery status indicator 506;
Tray 508 with icons for frequently used applications, such as:
   Icon 516 for telephone module 238, labeled “Phone,” which optionally includes an indicator 514 of the number of missed calls or voicemail messages;
   Icon 518 for e-mail client module 240, labeled “Mail,” which optionally includes an indicator 510 of the number of unread e-mails;
   Icon 520 for browser module 247, labeled “Browser;” and
   Icon 522 for video and music player module 252, also referred to as iPod (trademark of Apple Inc.) module 252, labeled “iPod;” and
Icons for other applications, such as:
   Icon 524 for IM module 241, labeled “Messages;”
   Icon 526 for calendar module 248, labeled “Calendar;”
   Icon 528 for image management module 244, labeled “Photos;”
   Icon 530 for camera module 243, labeled “Camera;”
   Icon 532 for online video module 255, labeled “Online Video;”
   Icon 534 for stocks widget 249-2, labeled “Stocks;”
   Icon 536 for map module 254, labeled “Maps;”
   Icon 538 for weather widget 249-1, labeled “Weather;”
   Icon 540 for alarm clock widget 249-4, labeled “Clock;”
   Icon 542 for workout support module 242, labeled “Workout Support;”
   Icon 544 for notes module 253, labeled “Notes;” and
   Icon 546 for a settings application or module, labeled “Settings,” which provides access to settings for device 200 and its various applications 236.

It should be noted that the icon labels illustrated in FIG. 5A are merely exemplary. For example, icon 522 for video and music player module 252 is optionally labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 5B illustrates an exemplary user interface on a device (e.g., device 400, FIG. 4A) with a touch-sensitive surface 551 (e.g., a tablet or touchpad 455, FIG. 4A) that is separate from the display 550 (e.g., touch screen display 212). Device 400 also, optionally, includes one or more contact intensity sensors (e.g., one or more of sensors 459) for detecting intensity of contacts on touch-sensitive surface 551 and/or one or more tactile output generators 457 for generating tactile outputs for a user of device 400.

Although some of the examples which follow will be given with reference to inputs on touch screen display 212 (where the touch-sensitive surface and the display are combined), in some embodiments, the device detects inputs on a touch-sensitive surface that is separate from the display, as shown in FIG. 5B. In some embodiments, the touch-sensitive surface (e.g., 551 in FIG. 5B) has a primary axis (e.g., 552 in FIG. 5B) that corresponds to a primary axis (e.g., 553 in FIG. 5B) on the display (e.g., 550). In accordance with these embodiments, the device detects contacts (e.g., 560 and 562 in FIG. 5B) with the touch-sensitive surface 551 at locations that correspond to respective locations on the display (e.g., in FIG. 5B, 560 corresponds to 568 and 562 corresponds to 570). In this way, user inputs (e.g., contacts 560 and 562, and movements thereof) detected by the device on the touch-sensitive surface (e.g., 551 in FIG. 5B) are used by the device to manipulate the user interface on the display (e.g., 550 in FIG. 5B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

FIG. 6A illustrates exemplary personal electronic device 600. Device 600 includes body 602. In some embodiments, device 600 includes some or all of the features described with respect to devices 200 and 400 (e.g., FIGS. 2A-4A). In some embodiments, device 600 has touch-sensitive display screen 604, hereafter touch screen 604. Alternatively, or in addition to touch screen 604, device 600 has a display and a touch-sensitive surface. As with devices 200 and 400, in some embodiments, touch screen 604 (or the touch-sensitive surface) has one or more intensity sensors for detecting intensity of contacts (e.g., touches) being applied. The one or more intensity sensors of touch screen 604 (or the touch-sensitive surface) provide output data that represents the intensity of touches. The user interface of device 600 responds to touches based on their intensity, meaning that touches of different intensities can invoke different user interface operations on device 600.

Techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, and International Patent Application Serial No. PCT/US2013/069483, titled “Device, Method, and Graphical User Interface for Transitioning Between Touch Input to Display Output Relationships,” filed Nov. 11, 2013, each of which is hereby incorporated by reference in their entirety.

In some embodiments, device 600 has one or more input mechanisms 606 and 608. Input mechanisms 606 and 608, if included, are physical. Examples of physical input mechanisms include push buttons and rotatable mechanisms. In some embodiments, device 600 has one or more attachment mechanisms. Such attachment mechanisms, if included, can permit attachment of device 600 with, for example, hats, eyewear, earrings, necklaces, shirts, jackets, bracelets, watch straps, chains, trousers, belts, shoes, purses, backpacks, and so forth. These attachment mechanisms permit device 600 to be worn by a user.

FIG. 6B depicts exemplary personal electronic device 600. In some embodiments, device 600 includes some or all of the components described with respect to FIGS. 2A, 2B, and 4A. Device 600 has bus 612 that operatively couples I/O section 614 with one or more computer processors 616 and memory 618. I/O section 614 is connected to display 604, which can have touch-sensitive component 622 and, optionally, touch-intensity sensitive component 624. In addition, I/O section 614 is connected with communication unit 630 for receiving application and operating system data, using Wi-Fi, Bluetooth, near field communication (NFC), cellular, and/or other wireless communication techniques. Device 600 includes input mechanisms 606 and/or 608. Input mechanism 606 is a rotatable input device or a depressible and rotatable input device, for example. Input mechanism 608 is a button, in some examples.

Input mechanism 608 is a microphone, in some examples. Personal electronic device 600 includes, for example, various sensors, such as GPS sensor 632, accelerometer 634, directional sensor 640 (e.g., compass), gyroscope 636, motion sensor 638, and/or a combination thereof, all of which are operatively connected to I/O section 614.

Memory 618 of personal electronic device 600 is a non-transitory computer-readable storage medium, for storing computer-executable instructions, which, when executed by one or more computer processors 616, for example, cause the computer processors to perform the techniques and processes described below. The computer-executable instructions, for example, are also stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. Personal electronic device 600 is not limited to the components and configuration of FIG. 6B, but can include other or additional components in multiple configurations.

As used here, the term “affordance” refers to a user-interactive graphical user interface object that is, for example, displayed on the display screen of devices 200, 400, 600, and/or 1000 (FIGS. 2A, 4A, 6A-6B and 10A-10H). For example, an image (e.g., icon), a button, and text (e.g., hyperlink) each constitutes an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 455 in FIG. 4A or touch-sensitive surface 551 in FIG. 5B) while the cursor is over a particular user interface element (e.g., a button, window, slider or other user interface element), the particular user interface element is adjusted in accordance with the detected input. In some implementations that include a touch screen display (e.g., touch-sensitive display system 212 in FIG. 2A or touch screen 212 in FIG. 5A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation) rather than being used to determine whether to perform a first operation or a second operation.

In some embodiments, a portion of a gesture is identified for purposes of determining a characteristic intensity. For example, a touch-sensitive surface receives a continuous swipe contact transitioning from a start location and reaching an end location, at which point the intensity of the contact increases. In this example, the characteristic intensity of the contact at the end location is based on only a portion of the continuous swipe contact, and not the entire swipe contact (e.g., only the portion of the swipe contact at the end location). In some embodiments, a smoothing algorithm is applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

### 3. Digital Assistant System

FIG. 7A illustrates a block diagram of digital assistant system 700 in accordance with various examples. In some examples, digital assistant system 700 is implemented on a standalone computer system. In some examples, digital assistant system 700 is distributed across multiple computers. In some examples, some of the modules and functions of the digital assistant are divided into a server portion and a client portion, where the client portion resides on one or more user devices (e.g., devices 104, 122, 200, 400, 600 and/or 1000) and communicates with the server portion (e.g., server system 108) through one or more networks, e.g., as shown in FIG. 1. In some examples, digital assistant system 700 is an implementation of server system 108 (and/or DA server 106) shown in FIG. 1. It should be noted that digital assistant system 700 is only one example of a digital assistant system, and that digital assistant system 700 can have more or fewer components than shown, can combine two or more components, or can have a different configuration or arrangement of the components. The various components shown in FIG. 7A are implemented in hardware, software instructions for execution by one or more processors, firmware, including one or more signal processing and/or application specific integrated circuits, or a combination thereof.

Digital assistant system 700 includes memory 702, one or more processors 704, input/output (I/O) interface 706, and network communications interface 708. These components can communicate with one another over one or more communication buses or signal lines 710.

In some examples, memory 702 includes a non-transitory computer-readable medium, such as high-speed random access memory and/or a non-volatile computer-readable storage medium (e.g., one or more magnetic disk storage devices, flash memory devices, or other non-volatile solid-state memory devices).

In some examples, I/O interface 706 couples input/output devices 716 of digital assistant system 700, such as displays, keyboards, touch screens, and microphones, to user interface module 722. I/O interface 706, in conjunction with user interface module 722, receives user inputs (e.g., voice input, keyboard inputs, touch inputs, etc.) and processes them accordingly. In some examples, e.g., when the digital assistant is implemented on a standalone user device, digital assistant system 700 includes any of the components and I/O communication interfaces described with respect to devices 200, 400, 600, and/or 1000 in FIGS. 2A, 4A, 6A-6B, and 10A-10H, respectively. In some examples, digital assistant system 700 represents the server portion of a digital assistant implementation, and can interact with the user through a client-side portion residing on a user device (e.g., devices 104, 200, 400, 600 and/or 1000).

In some examples, the network communications interface 708 includes wired communication port(s) 712 and/or wireless transmission and reception circuitry 714. The wired communication port(s) receives and send communication signals via one or more wired interfaces, e.g., Ethernet, Universal Serial Bus (USB), FIREWIRE, etc. The wireless circuitry 714 receives and sends RF signals and/or optical signals from/to communications networks and other communications devices. The wireless communications use any of a plurality of communications standards, protocols, and technologies, such as GSM, EDGE, CDMA, TDMA, Bluetooth, Wi-Fi, VoIP, Wi-MAX, or any other suitable communication protocol. Network communications interface 708 enables communication between digital assistant system 700 with networks, such as the Internet, an intranet, and/or a wireless network, such as a cellular telephone network, a wireless local area network (LAN), and/or a metropolitan area network (MAN), and other devices.

In some examples, memory 702, or the computer-readable storage media of memory 702, stores programs, modules, instructions, and data structures including all or a subset of: operating system 718, communications module 720, user interface module 722, one or more applications 724, and digital assistant module 726. In particular, memory 702, or the computer-readable storage media of memory 702, stores instructions for performing the processes described below. One or more processors 704 execute these programs, modules, and instructions, and reads/writes from/to the data structures.

Operating system 718 (e.g., Darwin, RTXC, LINUX, UNIX, iOS, OS X, WINDOWS, or an embedded operating system such as VxWorks) includes various software components and/or drivers for controlling and managing general system tasks (e.g., memory management, storage device control, power management, etc.) and facilitates communications between various hardware, firmware, and software components.

Communications module 720 facilitates communications between digital assistant system 700 with other devices over network communications interface 708. For example, communications module 720 communicates with RF circuitry 208 of electronic devices such as devices 200, 400, and 600 shown in FIGS. 2A, 4A, 6A-6B, respectively. Communications module 720 also includes various components for handling data received by wireless circuitry 714 and/or wired communications port 712.

User interface module 722 receives commands and/or inputs from a user via I/O interface 706 (e.g., from a keyboard, touch screen, pointing device, controller, and/or microphone), and generate user interface objects on a display. User interface module 722 also prepares and delivers outputs (e.g., speech, sound, animation, text, icons, vibrations, haptic feedback, light, etc.) to the user via the I/O interface 706 (e.g., through displays, audio channels, speakers, touch-pads, etc.).

Applications 724 include programs and/or modules that are configured to be executed by one or more processors 704. For example, if the digital assistant system is implemented on a standalone user device, applications 724 include user applications, such as games, a calendar application, a navigation application, or an email application. If digital assistant system 700 is implemented on a server, applications 724 include resource management applications, diagnostic applications, or scheduling applications, for example.

Memory 702 also stores digital assistant module 726 (or the server portion of a digital assistant). In some examples, digital assistant module 726 includes the following sub-modules, or a subset or superset thereof: input/output processing module 728, speech-to-text (STT) processing module 730, natural language processing module 732, dialogue flow processing module 734, task flow processing module 736, service processing module 738, and speech synthesis processing module 740. Each of these modules has access to one or more of the following systems or data and models of the digital assistant module 726, or a subset or superset thereof: ontology 760, vocabulary index 744, user data 748, task flow models 754, service models 756, and ASR systems 758.

In some examples, using the processing modules, data, and models implemented in digital assistant module 726, the digital assistant can perform at least some of the following: converting speech input into text; identifying a user's intent expressed in a natural language input received from the user; actively eliciting and obtaining information needed to fully infer the user's intent (e.g., by disambiguating words, games, intentions, etc.); determining the task flow for fulfilling the inferred intent; and executing the task flow to fulfill the inferred intent.

In some examples, as shown in FIG. 7B, I/O processing module 728 interacts with the user through I/O devices 716 in FIG. 7A or with a user device (e.g., devices 104, 200, 400, or 600) through network communications interface 708 in FIG. 7A to obtain user input (e.g., a speech input) and to provide responses (e.g., as speech outputs) to the user input. I/O processing module 728 optionally obtains contextual information associated with the user input from the user device, along with or shortly after the receipt of the user input. The contextual information includes user-specific data, vocabulary, and/or preferences relevant to the user input. In some examples, the contextual information also includes software and hardware states of the user device at the time the user request is received, and/or information related to the surrounding environment of the user at the time that the user request was received. In some examples, I/O processing module 728 also sends follow-up questions to, and receive answers from, the user regarding the user request. When a user request is received by I/O processing module 728 and the user request includes speech input, I/O processing module 728 forwards the speech input to STT processing module 730 (or speech recognizer) for speech-to-text conversions.

STT processing module 730 includes one or more ASR systems 758. The one or more ASR systems 758 can process the speech input that is received through I/O processing module 728 to produce a recognition result. Each ASR system 758 includes a front-end speech pre-processor. The front-end speech pre-processor extracts representative features from the speech input. For example, the front-end speech pre-processor performs a Fourier transform on the speech input to extract spectral features that characterize the speech input as a sequence of representative multi-dimensional vectors. Further, each ASR system 758 includes one or more speech recognition models (e.g., acoustic models and/or language models) and implements one or more speech recognition engines. Examples of speech recognition models include Hidden Markov Models, Gaussian-Mixture Models, Deep Neural Network Models, n-gram language models, and other statistical models. Examples of speech recognition engines include the dynamic time warping based engines and weighted finite-state transducers (WFST) based engines. The one or more speech recognition models and the one or more speech recognition engines are used to process the extracted representative features of the front-end speech pre-processor to produce intermediate recognitions results (e.g., phonemes, phonemic strings, and sub-words), and ultimately, text recognition results (e.g., words, word strings, or sequence of tokens). In some examples, the speech input is processed at least partially by a third-party service or on the user's device (e.g., device 104, 200, 400, or 600) to produce the recognition result. Once STT processing module 730 produces recognition results containing a text string (e.g., words, or sequence of words, or sequence of tokens), the recognition result is passed to natural language processing module 732 for intent deduction. In some examples, STT processing module 730 produces multiple candidate text representations of the speech input. Each candidate text representation is a sequence of words or tokens corresponding to the speech input. In some examples, each candidate text representation is associated with a speech recognition confidence score. Based on the speech recognition confidence scores, STT processing module 730 ranks the candidate text representations and provides the n-best (e.g., n highest ranked) candidate text representation(s) to natural language processing module 732 for intent deduction, where n is a predetermined integer greater than zero. For example, in one example, only the highest ranked (n=1) candidate text representation is passed to natural language processing module 732 for intent deduction. In another example, the five highest ranked (n=5) candidate text representations are passed to natural language processing module 732 for intent deduction.

More details on the speech-to-text processing are described in U.S. Utility application Ser. No. 13/236,942 for “Consolidating Speech Recognition Results,” filed on Sep. 20, 2011, the entire disclosure of which is incorporated herein by reference.

In some examples, STT processing module 730 includes and/or accesses a vocabulary of recognizable words via phonetic alphabet conversion module 731. Each vocabulary word is associated with one or more candidate pronunciations of the word represented in a speech recognition phonetic alphabet. In particular, the vocabulary of recognizable words includes a word that is associated with a plurality of candidate pronunciations. For example, the vocabulary includes the word “tomato” that is associated with the candidate pronunciations of [symbol] and [symbol] . Further, vocabulary words are associated with custom candidate pronunciations that are based on previous speech inputs from the user. Such custom candidate pronunciations are stored in STT processing module 730 and are associated with a particular user via the user's profile on the device. In some examples, the candidate pronunciations for words are determined based on the spelling of the word and one or more linguistic and/or phonetic rules. In some examples, the candidate pronunciations are manually generated, e.g., based on known canonical pronunciations.

In some examples, the candidate pronunciations are ranked based on the commonness of the candidate pronunciation. For example, the candidate pronunciation [symbol] is ranked higher than [symbol] , because the former is a more commonly used pronunciation (e.g., among all users, for users in a particular geographical region, or for any other appropriate subset of users). In some examples, candidate pronunciations are ranked based on whether the candidate pronunciation is a custom candidate pronunciation associated with the user. For example, custom candidate pronunciations are ranked higher than canonical candidate pronunciations. This can be useful for recognizing proper nouns having a unique pronunciation that deviates from canonical pronunciation. In some examples, candidate pronunciations are associated with one or more speech characteristics, such as geographic origin, nationality, or ethnicity. For example, the candidate pronunciation [symbol] is associated with the United States, whereas the candidate pronunciation [symbol] is associated with Great Britain. Further, the rank of the candidate pronunciation is based on one or more characteristics (e.g., geographic origin, nationality, ethnicity, etc.) of the user stored in the user's profile on the device. For example, it can be determined from the user's profile that the user is associated with the United States. Based on the user being associated with the United States, the candidate pronunciation [symbol] (associated with the United States) is ranked higher than the candidate pronunciation [symbol] (associated with Great Britain). In some examples, one of the ranked candidate pronunciations is selected as a predicted pronunciation (e.g., the most likely pronunciation).

When a speech input is received, STT processing module 730 is used to determine the phonemes corresponding to the speech input (e.g., using an acoustic model), and then attempt to determine words that match the phonemes (e.g., using a language model). For example, if STT processing module 730 first identifies the sequence of phonemes [symbol] corresponding to a portion of the speech input, it can then determine, based on vocabulary index 744, that this sequence corresponds to the word “tomato.”

In some examples, STT processing module 730 uses approximate matching techniques to determine words in an utterance. Thus, for example, the STT processing module 730 determines that the sequence of phonemes [symbol] corresponds to the word “tomato,” even if that particular sequence of phonemes is not one of the candidate sequence of phonemes for that word.

Natural language processing module 732 (“natural language processor”) of the digital assistant takes the n-best candidate text representation(s) (“word sequence(s)” or “token sequence(s)”) generated by STT processing module 730, and attempts to associate each of the candidate text representations with one or more “actionable intents” recognized by the digital assistant. An “actionable intent” (or “user intent”) represents a task that can be performed by the digital assistant, and can have an associated task flow implemented in task flow models 754. The associated task flow is a series of programmed actions and steps that the digital assistant takes in order to perform the task. The scope of a digital assistant's capabilities is dependent on the number and variety of task flows that have been implemented and stored in task flow models 754, or in other words, on the number and variety of “actionable intents” that the digital assistant recognizes. The effectiveness of the digital assistant, however, also dependents on the assistant's ability to infer the correct “actionable intent(s)” from the user request expressed in natural language.

In some examples, in addition to the sequence of words or tokens obtained from STT processing module 730, natural language processing module 732 also receives contextual information associated with the user request, e.g., from I/O processing module 728. The natural language processing module 732 optionally uses the contextual information to clarify, supplement, and/or further define the information contained in the candidate text representations received from STT processing module 730. The contextual information includes, for example, user preferences, hardware, and/or software states of the user device, sensor information collected before, during, or shortly after the user request, prior interactions (e.g., dialogue) between the digital assistant and the user, and the like. As described herein, contextual information is, in some examples, dynamic, and changes with time, location, content of the dialogue, and other factors.

In some examples, the natural language processing is based on, e.g., ontology 760. Ontology 760 is a hierarchical structure containing many nodes, each node representing either an “actionable intent” or a “property” relevant to one or more of the “actionable intents” or other “properties.” As noted above, an “actionable intent” represents a task that the digital assistant is capable of performing, i.e., it is “actionable” or can be acted on. A “property” represents a parameter associated with an actionable intent or a sub-aspect of another property. A linkage between an actionable intent node and a property node in ontology 760 defines how a parameter represented by the property node pertains to the task represented by the actionable intent node.

In some examples, ontology 760 is made up of actionable intent nodes and property nodes. Within ontology 760, each actionable intent node is linked to one or more property nodes either directly or through one or more intermediate property nodes. Similarly, each property node is linked to one or more actionable intent nodes either directly or through one or more intermediate property nodes. For example, as shown in FIG. 7C, ontology 760 includes a “restaurant reservation” node (i.e., an actionable intent node). Property nodes “restaurant,” “date/time” (for the reservation), and “party size” are each directly linked to the actionable intent node (i.e., the “restaurant reservation” node).

In addition, property nodes “cuisine,” “price range,” “phone number,” and “location” are sub-nodes of the property node “restaurant,” and are each linked to the “restaurant reservation” node (i.e., the actionable intent node) through the intermediate property node “restaurant.” For another example, as shown in FIG. 7C, ontology 760 also includes a “set reminder” node (i.e., another actionable intent node). Property nodes “date/time” (for setting the reminder) and “subject” (for the reminder) are each linked to the “set reminder” node. Since the property “date/time” is relevant to both the task of making a restaurant reservation and the task of setting a reminder, the property node “date/time” is linked to both the “restaurant reservation” node and the “set reminder” node in ontology 760.

An actionable intent node, along with its linked property nodes, is described as a “domain.” In the present discussion, each domain is associated with a respective actionable intent, and refers to the group of nodes (and the relationships there between) associated with the particular actionable intent. For example, ontology 760 shown in FIG. 7C includes an example of restaurant reservation domain 762 and an example of reminder domain 764 within ontology 760. The restaurant reservation domain includes the actionable intent node “restaurant reservation,” property nodes “restaurant,” “date/time,” and “party size,” and sub-property nodes “cuisine,” “price range,” “phone number,” and “location.” Reminder domain 764 includes the actionable intent node “set reminder,” and property nodes “subject” and “date/time.” In some examples, ontology 760 is made up of many domains. Each domain shares one or more property nodes with one or more other domains. For example, the “date/time” property node is associated with many different domains (e.g., a scheduling domain, a travel reservation domain, a movie ticket domain, etc.), in addition to restaurant reservation domain 762 and reminder domain 764.

While FIG. 7C illustrates two example domains within ontology 760, other domains include, for example, “find a movie,” “initiate a phone call,” “find directions,” “schedule a meeting,” “send a message,” and “provide an answer to a question,” “read a list,” “providing navigation instructions,” “provide instructions for a task” and so on. A “send a message” domain is associated with a “send a message” actionable intent node, and further includes property nodes such as “recipient(s),” “message type,” and “message body.” The property node “recipient” is further defined, for example, by the sub-property nodes such as “recipient name” and “message address.”

In some examples, ontology 760 includes all the domains (and hence actionable intents) that the digital assistant is capable of understanding and acting upon. In some examples, ontology 760 is modified, such as by adding or removing entire domains or nodes, or by modifying relationships between the nodes within the ontology 760.

In some examples, nodes associated with multiple related actionable intents are clustered under a “super domain” in ontology 760. For example, a “travel” super-domain includes a cluster of property nodes and actionable intent nodes related to travel. The actionable intent nodes related to travel includes “airline reservation,” “hotel reservation,” “car rental,” “get directions,” “find points of interest,” and so on. The actionable intent nodes under the same super domain (e.g., the “travel” super domain) have many property nodes in common. For example, the actionable intent nodes for “airline reservation,” “hotel reservation,” “car rental,” “get directions,” and “find points of interest” share one or more of the property nodes “start location,” “destination,” “departure date/time,” “arrival date/time,” and “party size.”

In some examples, each node in ontology 760 is associated with a set of words and/or phrases that are relevant to the property or actionable intent represented by the node. The respective set of words and/or phrases associated with each node are the so-called “vocabulary” associated with the node. The respective set of words and/or phrases associated with each node are stored in vocabulary index 744 in association with the property or actionable intent represented by the node. For example, returning to FIG. 7B, the vocabulary associated with the node for the property of “restaurant” includes words such as “food,” “drinks,” “cuisine,” “hungry,” “eat,” “pizza,” “fast food,” “meal,” and so on. For another example, the vocabulary associated with the node for the actionable intent of “initiate a phone call” includes words and phrases such as “call,” “phone,” “dial,” “ring,” “call this number,” “make a call to,” and so on. The vocabulary index 744 optionally includes words and phrases in different languages.

Natural language processing module 732 receives the candidate text representations (e.g., text string(s) or token sequence(s)) from STT processing module 730, and for each candidate representation, determines what nodes are implicated by the words in the candidate text representation. In some examples, if a word or phrase in the candidate text representation is found to be associated with one or more nodes in ontology 760 (via vocabulary index 744), the word or phrase “triggers” or “activates” those nodes. Based on the quantity and/or relative importance of the activated nodes, natural language processing module 732 selects one of the actionable intents as the task that the user intended the digital assistant to perform. In some examples, the domain that has the most “triggered” nodes is selected. In some examples, the domain having the highest confidence value (e.g., based on the relative importance of its various triggered nodes) is selected. In some examples, the domain is selected based on a combination of the number and the importance of the triggered nodes. In some examples, additional factors are considered in selecting the node as well, such as whether the digital assistant has previously correctly interpreted a similar request from a user.

User data 748 includes user-specific information, such as user-specific vocabulary, user preferences, user address, user's default and secondary languages, user's contact list, and other short-term or long-term information for each user. In some examples, natural language processing module 732 uses the user-specific information to supplement the information contained in the user input to further define the user intent. For example, for a user request “invite my friends to my birthday party,” natural language processing module 732 is able to access user data 748 to determine who the “friends” are and when and where the “birthday party” would be held, rather than requiring the user to provide such information explicitly in his/her request.

It should be recognized that in some examples, natural language processing module 732 is implemented using one or more machine learning mechanisms (e.g., neural networks). In particular, the one or more machine learning mechanisms are configured to receive a candidate text representation and contextual information associated with the candidate text representation. Based on the candidate text representation and the associated contextual information, the one or more machine learning mechanisms are configured to determine intent confidence scores over a set of candidate actionable intents. Natural language processing module 732 can select one or more candidate actionable intents from the set of candidate actionable intents based on the determined intent confidence scores. In some examples, an ontology (e.g., ontology 760) is also used to select the one or more candidate actionable intents from the set of candidate actionable intents.

Other details of searching an ontology based on a token string are described in U.S. Utility application Ser. No. 12/341,743 for “Method and Apparatus for Searching Using An Active Ontology,” filed Dec. 22, 2008, the entire disclosure of which is incorporated herein by reference.

In some examples, once natural language processing module 732 identifies an actionable intent (or domain) based on the user request, natural language processing module 732 generates a structured query to represent the identified actionable intent. In some examples, the structured query includes parameters for one or more nodes within the domain for the actionable intent, and at least some of the parameters are populated with the specific information and requirements specified in the user request. For example, the user says “Make me a dinner reservation at a sushi place at 7.” In this case, natural language processing module 732 is able to correctly identify the actionable intent to be “restaurant reservation” based on the user input. According to the ontology, a structured query for a “restaurant reservation” domain includes parameters such as {Cuisine}, {Time}, {Date}, {Party Size}, and the like. In some examples, based on the speech input and the text derived from the speech input using STT processing module 730, natural language processing module 732 generates a partial structured query for the restaurant reservation domain, where the partial structured query includes the parameters {Cuisine=“Sushi”} and {Time=“7 pm”}. However, in this example, the user's utterance contains insufficient information to complete the structured query associated with the domain. Therefore, other necessary parameters such as {Party Size} and {Date} are not specified in the structured query based on the information currently available. In some examples, natural language processing module 732 populates some parameters of the structured query with received contextual information. For example, in some examples, if the user requested a sushi restaurant “near me,” natural language processing module 732 populates a {location} parameter in the structured query with GPS coordinates from the user device.

In some examples, natural language processing module 732 identifies multiple candidate actionable intents for each candidate text representation received from STT processing module 730. Further, in some examples, a respective structured query (partial or complete) is generated for each identified candidate actionable intent. Natural language processing module 732 determines an intent confidence score for each candidate actionable intent and ranks the candidate actionable intents based on the intent confidence scores. In some examples, natural language processing module 732 passes the generated structured query (or queries), including any completed parameters, to task flow processing module 736 (“task flow processor”). In some examples, the structured query (or queries) for the m-best (e.g., m highest ranked) candidate actionable intents are provided to task flow processing module 736, where m is a predetermined integer greater than zero. In some examples, the structured query (or queries) for the m-best candidate actionable intents are provided to task flow processing module 736 with the corresponding candidate text representation(s).

Other details of inferring a user intent based on multiple candidate actionable intents determined from multiple candidate text representations of a speech input are described in U.S. Utility application Ser. No. 14/298,725 for “System and Method for Inferring User Intent From Speech Inputs,” filed Jun. 6, 2014, the entire disclosure of which is incorporated herein by reference.

Task flow processing module 736 is configured to receive the structured query (or queries) from natural language processing module 732, complete the structured query, if necessary, and perform the actions required to “complete” the user's ultimate request. In some examples, the various procedures necessary to complete these tasks are provided in task flow models 754. In some examples, task flow models 754 include procedures for obtaining additional information from the user and task flows for performing actions associated with the actionable intent.

As described above, in order to complete a structured query, task flow processing module 736 needs to initiate additional dialogue with the user in order to obtain additional information, and/or disambiguate potentially ambiguous utterances. When such interactions are necessary, task flow processing module 736 invokes dialogue flow processing module 734 to engage in a dialogue with the user. In some examples, dialogue flow processing module 734 determines how (and/or when) to ask the user for the additional information and receives and processes the user responses. The questions are provided to and answers are received from the users through I/O processing module 728. In some examples, dialogue flow processing module 734 presents dialogue output to the user via audio and/or visual output, and receives input from the user via spoken or physical (e.g., clicking) responses. Continuing with the example above, when task flow processing module 736 invokes dialogue flow processing module 734 to determine the “party size” and “date” information for the structured query associated with the domain “restaurant reservation,” dialogue flow processing module 734 generates questions such as “For how many people?” and “On which day?” to pass to the user. Once answers are received from the user, dialogue flow processing module 734 then populates the structured query with the missing information, or pass the information to task flow processing module 736 to complete the missing information from the structured query.

Once task flow processing module 736 has completed the structured query for an actionable intent, task flow processing module 736 proceeds to perform the ultimate task associated with the actionable intent. Accordingly, task flow processing module 736 executes the steps and instructions in the task flow model according to the specific parameters contained in the structured query. For example, the task flow model for the actionable intent of “restaurant reservation” includes steps and instructions for contacting a restaurant and actually requesting a reservation for a particular party size at a particular time. For example, using a structured query such as: {restaurant reservation, restaurant=ABC Café, date=Mar. 12, 2012, time=7 pm, party size=5}, task flow processing module 736 performs the steps of: (1) logging onto a server of the ABC Café or a restaurant reservation system such as OPENTABLE®, (2) entering the date, time, and party size information in a form on the website, (3) submitting the form, and (4) making a calendar entry for the reservation in the user's calendar.

In some examples, task flow processing module 736 employs the assistance of service processing module 738 (“service processing module”) to complete a task requested in the user input or to provide an informational answer requested in the user input. For example, service processing module 738 acts on behalf of task flow processing module 736 to make a phone call, set a calendar entry, invoke a map search, invoke or interact with other user applications installed on the user device, and invoke or interact with third-party services (e.g., a restaurant reservation portal, a social networking website, a banking portal, etc.). In some examples, the protocols and application programming interfaces (API) required by each service are specified by a respective service model among service models 756. Service processing module 738 accesses the appropriate service model for a service and generates requests for the service in accordance with the protocols and APIs required by the service according to the service model.

For example, if a restaurant has enabled an online reservation service, the restaurant submits a service model specifying the necessary parameters for making a reservation and the APIs for communicating the values of the necessary parameter to the online reservation service. When requested by task flow processing module 736, service processing module 738 establishes a network connection with the online reservation service using the web address stored in the service model, and sends the necessary parameters of the reservation (e.g., time, date, party size) to the online reservation interface in a format according to the API of the online reservation service.

In some examples, natural language processing module 732, dialogue flow processing module 734, and task flow processing module 736 are used collectively and iteratively to infer and define the user's intent, obtain information to further clarify and refine the user intent, and finally generate a response (i.e., an output to the user, or the completion of a task) to fulfill the user's intent. The generated response is a dialogue response to the speech input that at least partially fulfills the user's intent. Further, in some examples, the generated response is output as a speech output. In these examples, the generated response is sent to speech synthesis processing module 740 (e.g., speech synthesizer) where it can be processed to synthesize the dialogue response in speech form. In yet other examples, the generated response is data content relevant to satisfying a user request in the speech input.

In examples where task flow processing module 736 receives multiple structured queries from natural language processing module 732, task flow processing module 736 initially processes the first structured query of the received structured queries to attempt to complete the first structured query and/or execute one or more tasks or actions represented by the first structured query. In some examples, the first structured query corresponds to the highest ranked actionable intent. In other examples, the first structured query is selected from the received structured queries based on a combination of the corresponding speech recognition confidence scores and the corresponding intent confidence scores. In some examples, if task flow processing module 736 encounters an error during processing of the first structured query (e.g., due to an inability to determine a necessary parameter), the task flow processing module 736 can proceed to select and process a second structured query of the received structured queries that corresponds to a lower ranked actionable intent. The second structured query is selected, for example, based on the speech recognition confidence score of the corresponding candidate text representation, the intent confidence score of the corresponding candidate actionable intent, a missing necessary parameter in the first structured query, or any combination thereof.

Speech synthesis processing module 740 is configured to synthesize speech outputs for presentation to the user. Speech synthesis processing module 740 synthesizes speech outputs based on text provided by the digital assistant. For example, the generated dialogue response is in the form of a text string. Speech synthesis processing module 740 converts the text string to an audible speech output. Speech synthesis processing module 740 uses any appropriate speech synthesis technique in order to generate speech outputs from text, including, but not limited, to concatenative synthesis, unit selection synthesis, diphone synthesis, domain-specific synthesis, formant synthesis, articulatory synthesis, hidden Markov model (HMM) based synthesis, and sinewave synthesis. In some examples, speech synthesis processing module 740 is configured to synthesize individual words based on phonemic strings corresponding to the words. For example, a phonemic string is associated with a word in the generated dialogue response. The phonemic string is stored in metadata associated with the word. Speech synthesis processing module 740 is configured to directly process the phonemic string in the metadata to synthesize the word in speech form.

In some examples, instead of (or in addition to) using speech synthesis processing module 740, speech synthesis is performed on a remote device (e.g., the server system 108), and the synthesized speech is sent to the user device for output to the user. For example, this can occur in some implementations where outputs for a digital assistant are generated at a server system. And because server systems generally have more processing power or resources than a user device, it is possible to obtain higher quality speech outputs than would be practical with client-side synthesis.

Additional details on digital assistants can be found in the U.S. Utility application Ser. No. 12/987,982, entitled “Intelligent Automated Assistant,” filed Jan. 10, 2011, and U.S. Utility application Ser. No. 13/251,088, entitled “Generating and Processing Task Items That Represent Tasks to Perform,” filed Sep. 30, 2011, the entire disclosures of which are incorporated herein by reference.

### 4. Foundation Model

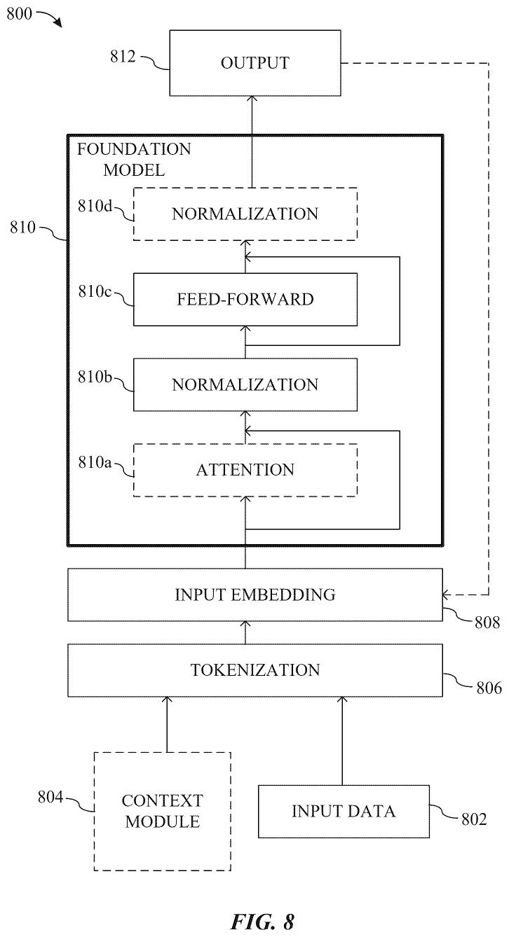

FIG. 8 illustrates exemplary foundation system 800 including foundation model 810, according to various examples. In some examples, the blocks of foundation system 800 are combined, the order of the blocks is changed, and/or blocks of foundation system 800 are removed.

Foundation system 800 includes tokenization module 806, input embedding module 808, and foundation model 810 which use input data 802 and, optionally, context module 804 to train foundation model 810 to process input data 802 to determine output 812.

In some examples, the various components of digital assistant system 700 (e.g., digital assistant module 726, operating system (e.g., 226 or 718), and/or software applications (e.g., 236 and/or 724) installed on device 104, 200, 400, 600, and/or 1000) include and/or are implemented using generative artificial intelligence (AI) such as foundation model 810. In some examples, foundation model 810 include a subset of machine learning models that are trained to generate text, images, and/or other media based on sets of training data that include large amounts of a particular type of data. Foundation model 810 is then integrated into the components of digital assistant system 700 or otherwise available to digital assistant system 700, (e.g., digital assistant module 726, operating system (e.g., 226 or 718), and/or software applications (e.g., 236 and/or 724) installed on device 104, 200, 400, 600, and/or 1000, and/or via an API) to provide text, images, and/or other media that digital assistant system 700 uses to determine tasks, perform tasks, and/or provide the outputs of tasks.

Foundation models are generally trained using large sets unlabeled data first and then later adapted to a specific task within the architecture of digital assistant system 700. Thus, a specific task or type of output is not encoded into the foundation models, rather the trained foundation model emerges based on the self-supervised training using the unlabeled data. The trained foundation model is then adapted to a variety of tasks based on the needs of the digital assistant system 700 to efficiently perform tasks for a user.

Generative AI models, such as foundation model 810, are trained on large quantities of data with self-supervised or semi-supervised learning to be adapted to a specific downstream task. For example, foundation model 810 is trained with large sets of different images and corresponding text or metadata to determine the description of newly captured image data as output 812. These descriptions can then be used by digital assistant system 700 to determine user intent, tasks, and/or other information that can be used to perform tasks. For example, generative AI models such as Midjourney, DALL-E, and stable diffusion are trained on large sets of images and are able to convert text to a generated image.

Large language models (LLM) are a type of foundation model that provide text output after being trained on large sets of input text data. As with other foundation models, LLM's can be trained in a self-supervised manner and thus the output of different LLM's trained on the same large set of input text can be different. These LLM's can then be adapted for use with digital assistant system 700 to specific types of text. Thus, in some examples, the LLM is trained to determine a summary of text provided to the LLM as an input while in other examples, the LLM is trained to predict text based on the set of input text. Thus, the LLM can efficiently process large amounts of input text to provide the digital assistant with text that can be used to determine and/or perform tasks. For example, GPT and LLAMA are exemplary large language models that process large amounts of input text and generates text that can be used by a digital assistant, a software application, and/or an operating system.

In some examples, the LLM may be trained in a semi-supervised manner and/or provided human feedback to refine the output of the LLM. In this way, the LLM may be adapted to provide the specific output required for a particular task of digital assistant system 700, such as a summary of large amounts of text or a task for digital assistant system 700 to perform. Further, the input provided to the LLM can be adapted such that the LLM processes data as or more efficiently than digital assistant system 700 could without the use of the LLM.

Once foundation model 810 (e.g., an LLM) has been fully trained, foundation model 810 can process input data 802 as discussed below to determine output 812 which may be used to further train foundation model 810 or can be processed by digital assistant system 700 to perform a task and/or provide an output to the user.

Specifically, input data 802 is received and provided to tokenization module 806 which converts input data 802 into a token and/or a series of tokens which can be processed by input embedding module 808 into a format that is understood by foundation model 810. Tokenization module 806 converts input data into a series of characters that has a specific semantic meaning to foundation model 810.

In some examples, tokenization module 806 tokenizes contextual data from context module 804 to add further information to input data 802 for processing by foundation model 810. For example, context module 804 can provide information related to input data 802 such as a location that input data 802 was received, a time that input data 802 was received, other data that was received contemporaneously with input data 802, and/or other contextual information that relates to input data 802. Tokenization module 806 can then tokenize this contextual data with input data 802 to be provided to foundation model 810.

After input data 802 has been tokenized, input data 802 is provided to input embedding module 808 to convert the tokens to a vector representation that can be processed by foundation model 810. In some examples, the vector representation includes information provided by context module 804. In some examples, the vector representation includes information determined from output 812. Accordingly, input embedding module 808 converts the various data provided as an input into a format that foundation model 810 can parse and process.

For example, when foundation model 810 is a large language model (LLM) tokenization module 806 converts input data 802 into text which is then converted into a vector representation by input embedding module 808 that can be processed by foundation model 810 to determine a response to input data 802 as output 812 or to determine a summary of input data 802 as output 812. As another example, when foundation model 810 is a model that has been trained to determine descriptions of images, input data 802 of images can be tokenized into characters and then converted into a vector representation by input embedding module 808 that is processed by foundation model 810 to determine a description of the images as output 812.

Foundation model 810 processes the received vector representation using a series of layers including, in some embodiments, attention layer 810a, normalization layer 810b, feed-forward layer 810c, and/or normalization layer 810d. In some examples, foundation model 810 includes additional layers similar to these layers to further process the vector representation. Accordingly, foundation model 810 can be customized based on the specific task that foundation model 810 has been trained to perform. Each of the layers of foundation model 810 perform a specific task to process the vector representation into output 812.

Attention layer 810a provides access to all portions of the vector representation at the same time, increasing the speed at which the vector representation can be processed and ensuring that the data is processed equally across the portions of the vector representation. Normalization layer 810b and normalization layer 810d scale the data that is being processed by foundation model 810 up or down based on the needs of the other layers of foundation model 810. This allows foundation model 810 to manipulate the data during processing as needed. Feed-forward layer 810c assigns weights to the data that is being processed and provides the data for further processing within foundation model 810. These layers work together to process the vector representation provided to foundation model 810 to determine the appropriate output 812.

For example, as discussed above, when foundation model 810 is a large language model (LLM) foundation model 810 processes input text to determine a summary and/or further follow-up text as output 812. As another example, as discussed above, when foundation model 810 is a model trained to determine descriptions of images, foundation model 810 processes input images to determine a description of the image and/or tasks that can be performed based on the content of the images as output 812.

In some examples, output 812 is further processed by digital assistant system 700 (e.g., digital assistant module 726, operating system (e.g., 226 or 718), software applications (e.g., 236 and/or 724) installed on device 104, 200, 400, 600, and/or 1000) to provide an output or execute a task. For example, when output 812 is a sentence describing a task that digital assistant system 700 has performed, digital assistant system 700 can use the text to create a visual or audio output to be provided to a user. As another example, when output 812 is text that includes a function and a parameter for the function, digital assistant system 700 can perform a function call to execute the function with the provided parameter

In some examples, digital assistant system 700 includes multiple generative AI (e.g., foundation) models that work together to process data in an efficient manner. In some examples, components of digital assistant system 700 may be replaced with generative AI (e.g., foundation) models trained to perform the same function as the component. In some examples, these generative AI models are more efficient than traditional components and/or provide more flexible processing and/or outputs for digital assistant system 700 to utilize.

### 5. Process for Task Performance Using Software Objects

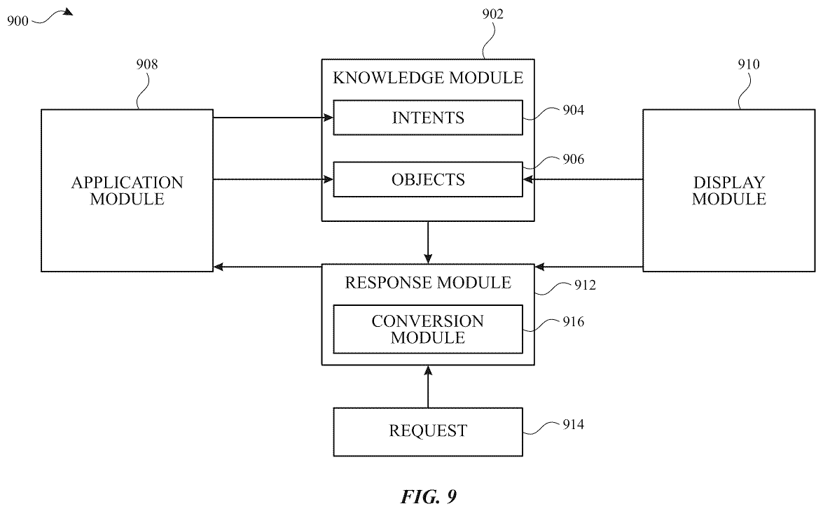

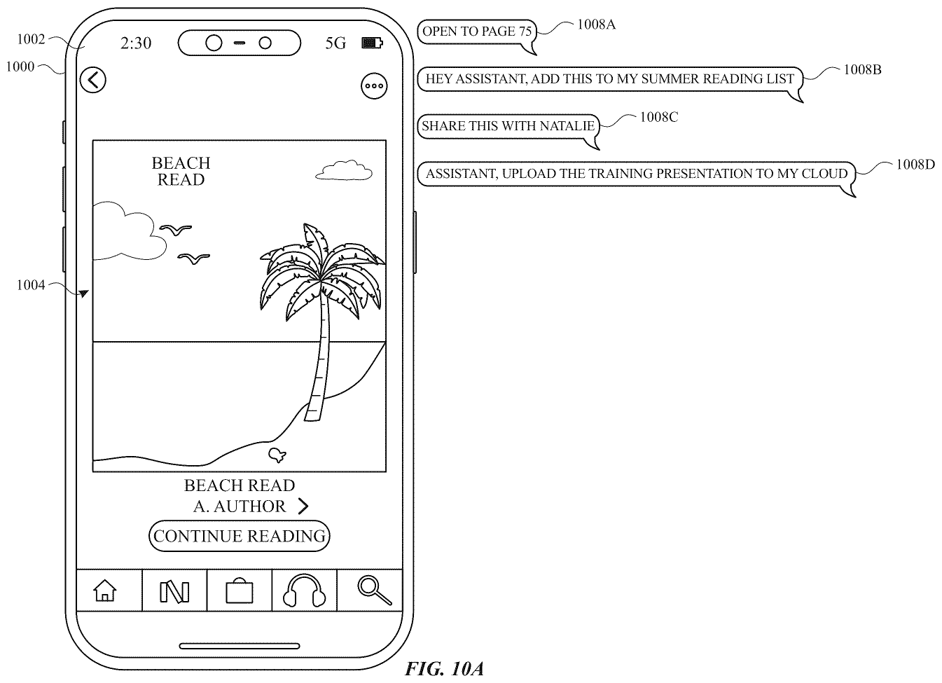

FIG. 9 is a block diagram illustrating task system 900 for performing tasks using software objects, according to various examples. System 900 is implemented, for example, using one or more electronic devices (e.g., a mobile device, a personal computer, a wearable electronic device, and/or a peripheral device) that is in communication with one or more display generation components (e.g., display 1002) and implements a digital assistant (e.g., digital assistant system 700, foundation system 800). In some examples, system 900 is implemented using a client-server system (e.g., system 100), and the functions of system 900 are divided up in any manner between the server (e.g., DA server 106) and a client device (e.g., 104, 200, 400, 600, and/or 1000). In other examples, the functions of system 900 are divided up between the server and multiple client devices. Thus, while some functions of system 900 are described herein as being performed by particular devices of a client-server system, it will be appreciated that system 1000 is not so limited. In other examples, system 900 is implemented using only a client device (e.g., 104, 200, 400, 600, and/or 1000) or only multiple client devices. Some functions of system 900 are, optionally, combined, the order of some functions is, optionally, changed, and some functions are, optionally, omitted. In some examples, additional functions may be performed in combination with the described functions of system 900.

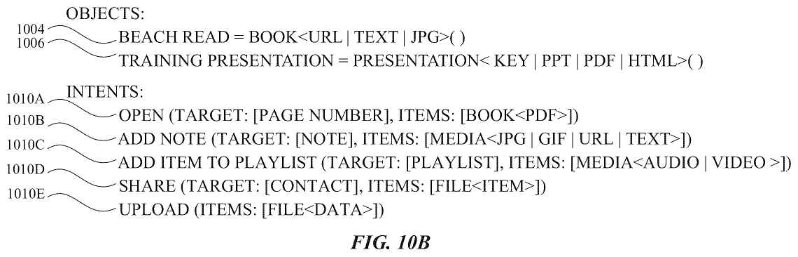

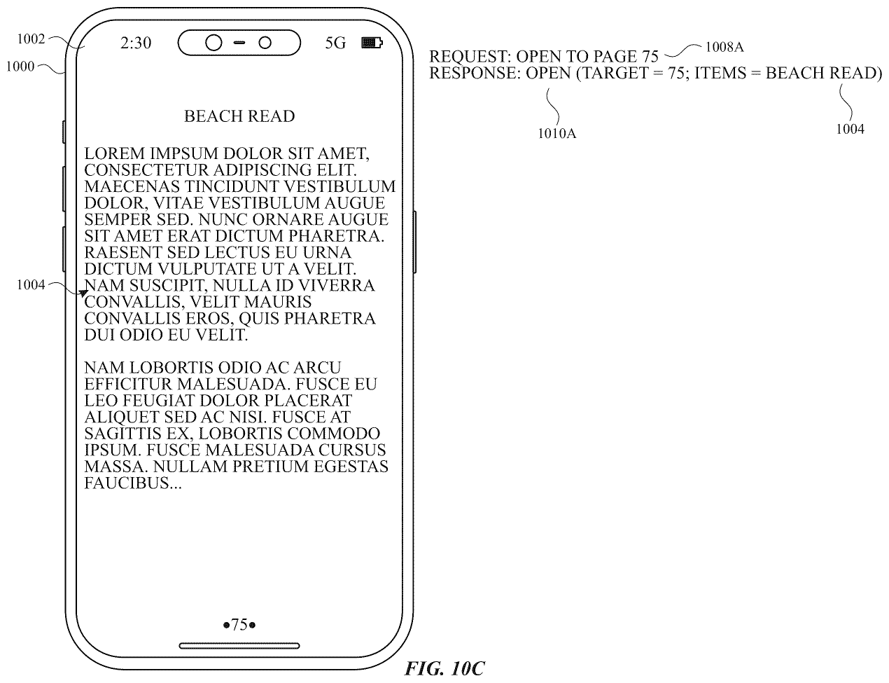

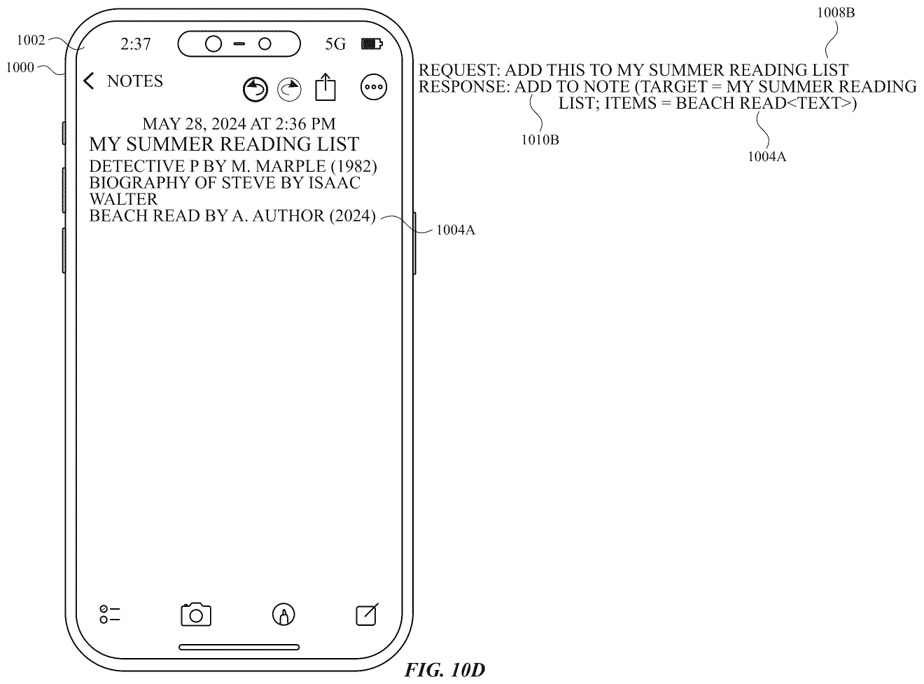

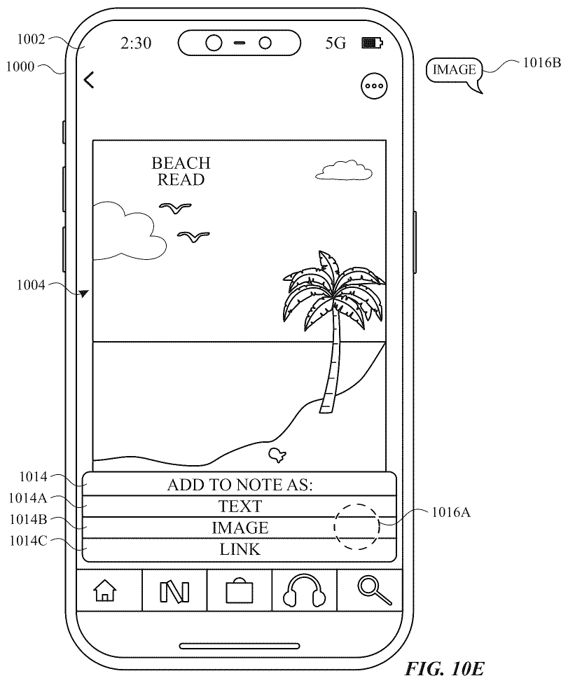

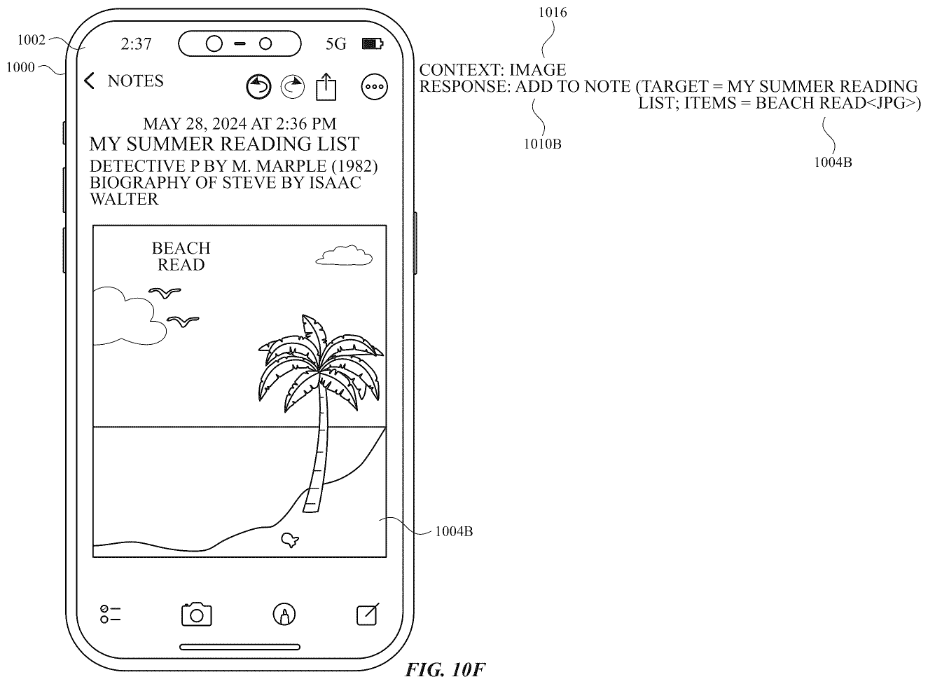

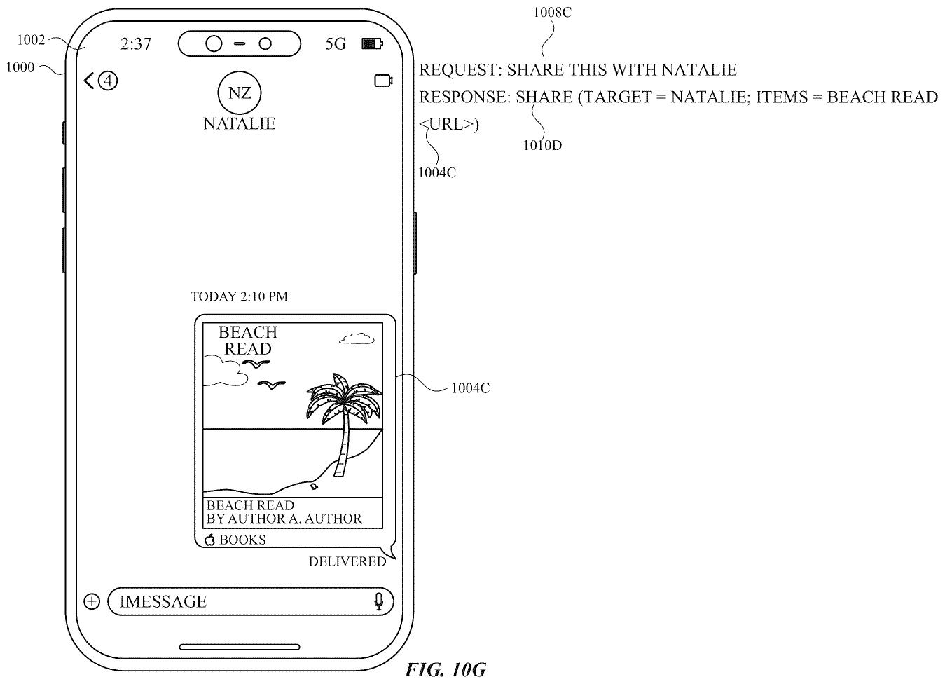

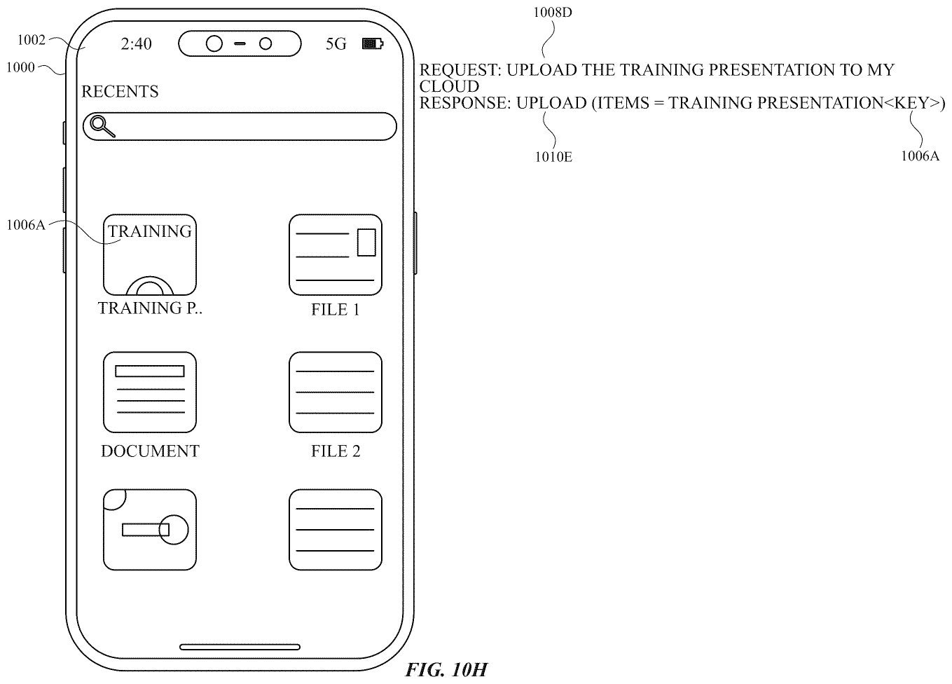

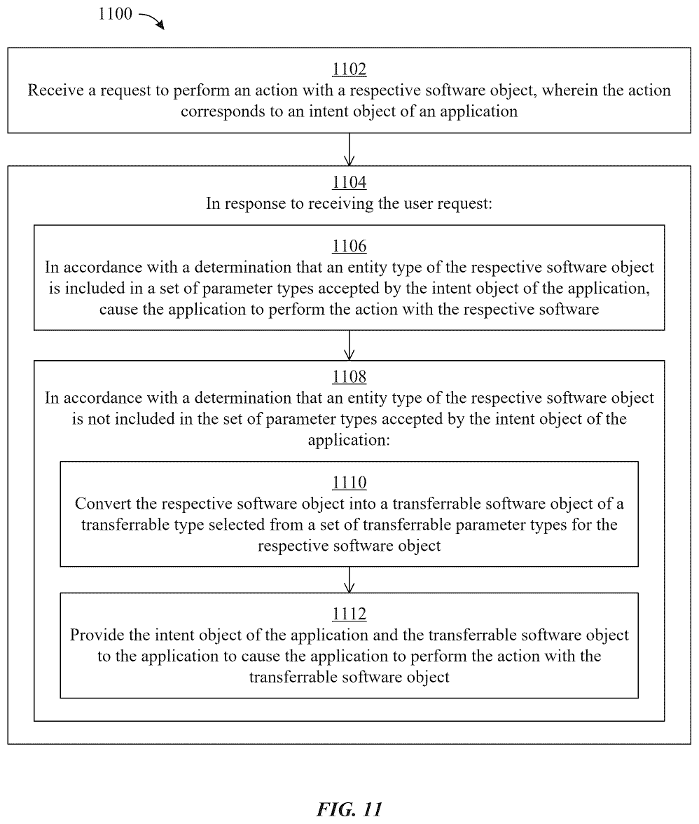

As illustrated in FIG. 9, task system 900 includes knowledge module 902, application module 908, display module 910, and response module 912. For example, task system 900 is implemented as part of a digital assistant system (e.g., digital assistant system, e.g., in conjunction with foundation system 800) for use in interpreting and operationalizing user intents from an input. For example, task system 900 is used when performing processes such as described below with respect to FIGS. 10A-10H.

Knowledge module 902 manages a knowledge base for a digital assistant (e.g., digital assistant module 726 of digital assistant system 700 and/or foundation system 800, described above). Knowledge module 902 includes libraries of intents 904 and objects 906. The library of intents 904 includes representations of intent data structures (e.g., 1010A-1010E, described below), which define tasks that can be performed by a computer system implementing task system 900. The intent data structures include fields for inputs and/or parameters (e.g., mandatory or optional) for performing the task and can be provided to an application or service (e.g., along with populated inputs/parameters) to cause performance of the task. The representation of an intent data structure specifies a set of types (e.g., classes or formats of data, objects, and/or entities) accepted for each input/parameter field, as described in further detail with respect to FIGS. 10A-12B. In some embodiments, the representation of an intent data structure may include additional task metadata (e.g., developer-provided information and/or contextual information relevant to task performance, such as keywords or natural-language vocabulary corresponding to the task).

The library of objects 906 includes representations of software objects (e.g., 1004 and 1006, described below), which define specific object instances, data items, and/or application entities that exist on and/or are accessible to the computer system implementing task system 900. The representation of a software object includes object identifiers or pointers (e.g., defining or pointing to the “location” of the particular data object, instance, or entity within the computer system) and identify the current type (e.g., class or format) of the particular software object. The representation of a software object also specifies a set of transferrable types that the particular object can be converted (e.g., cast) into, as described in further detail with respect to FIGS. 10A-12. For example, the current type of the particular software object (e.g., the type or class as currently defined within an application and/or computer system 600) may be a developer-defined (e.g., application-specific) type, such as a class or type defined by the software application that donates the particular software object (e.g., via application module 908, as described below), or the current type may be a standardized or system-defined object type, such as a primitive/built-in type, uniform type, and/or file extension. For example, the set of transferrable types include standardized/system-defined object types, but not developer-defined types. In some embodiments, the representation of a particular software object includes additional object metadata (e.g., developer-provided information and/or contextual information relevant to task performance, such as keywords or natural-language vocabulary corresponding to the object).

Application module 908 is an interface (e.g., an API layer) linking task system 900 to one or more software applications (e.g., first- and/or third-party applications) installed on and/or otherwise accessible to the computer system implementing task system 900. As illustrated in FIG. 9, the one or more software applications can “donate” one or more intents (e.g., intent data structures representing actions or tasks that a particular application can perform) and/or one or more objects (e.g., representations of software objects that exist within and/or are created, owned, and/or managed by the particular application) to include in knowledge module 902 via application module 908. For example, application module 908 manages donations of intents and/or objects from the one or more software applications by requesting donations of (e.g., fetching) intents and/or objects from the one or more software applications and/or handling requests from the one or more software applications to donate (e.g., push) intents and/or objects to knowledge module 902. In some embodiments, an application's intents and/or objects are donated upon installation (e.g., a static donation). For example, application module 908 extracts the intents and/or objects from the application's installation files. In some embodiments, an application can donate intents and/or objects at other times, for instance, when the application is updated (e.g., extracting intents and/or objects from application update files) and/or upon request (e.g., by the one or more software applications or task system 900). In some embodiments, application module 908 extracts (e.g., from the application and/or application's files) and/or generates some or all of the metadata included with the representations of donated intents and/or objects in knowledge module 902 (e.g., current, transferrable, and/or accepted type information, the identity of the donor application, the identity of other applications that can use the donated intents/objects, natural-language processing information, and the like). In some embodiments, an application can perform a given task using objects of the application's own developer-defined types in addition to the accepted parameter/input types defined for the intent data structure the task.

For example, a reader application may donate intents for opening book media, playing book media (e.g., as an audio book or dictation), navigating within book media, searching book media, and/or searching a library of book media, and may donate objects corresponding to particular book media items in a user's library. As another example, a cloud storage application may donate intents for uploading a data item (e.g., file), downloading a data item, deleting a data item, creating a new version of a data item, and/or editing a data item, and may donate objects corresponding particular data items (e.g., files) in the user's cloud storage account. As noted above, in some embodiments, application-donated intents and/or objects may include relevant metadata. For example, an application's developer may include metadata defining natural-language and/or keyword vocabulary for an application-specific task or item, such as providing the vocabulary “open to,” “flip to,” and “turn to” with the intent for opening book media and/or providing the title, author name, and series name for a particular book media item.

Display module 910 is an interface providing display inspection information to task system 900. For example, display module 910 provides information identifying content currently being displayed via one or more display generation components of the computer system, including identifying any software objects that are currently visible. In some embodiments, knowledge module 902 updates the library of objects 906 based on the display inspection information, for example, in order to keep track of which of the available software objects are currently displayed.

Response module 912 receives request 914, representing a user request to perform a task with a particular software object. For example, request 914 may be a natural-language user request and/or a pre-processed (e.g., tokenized and/or interpreted, as described with respect to FIG. 8) version of a user request. In response to receiving request 914, response module 912 generates a response plan, using the libraries of intents 904 and objects 906 maintained by knowledge module 902 to determine an intent data structure that corresponds to the requested task and to populate the determined intent data structure with input/parameter values for performing the requested task with the particular software object. For example, response module 912 can search the pre-compiled intents 904 and objects 906 to determine candidate intents and objects for responding to request 914, without needing to individually poll applications or services for available intents and objects.

As discussed above, the representation of the intent data structure specifies the set of types accepted for each input/parameter field of the intent data structure. Accordingly, if the current type of the particular software object is not included in the specified set, response module 912 uses conversion module 916 to convert the particular software object to one of the transferrable types specified by the representation of the particular software object, thereby allowing the particular software object to be used as an input/parameter for the task. For example, conversion module 916 generates a new version of the particular software object in the selected type and/or requests export (e.g., from the object's donor application) of the particular software object as an object of the selected type.

Response module 912 then executes the response plan by providing (e.g., via application module 908) the populated intent data structure to an application or service (e.g., the application that donated the determined intent) to cause performance of the corresponding task with the populated inputs/parameters, including the particular software object or converted version thereof.

Additional details and examples of generating and executing a response plan for a user request, including determining and populating an intent data structure, are described herein with respect to FIGS. 10A-12B.

FIGS. 10A-10H illustrate system 1000 for performing tasks using software objects, according to various examples. System 1000 is implemented, for example, using one or more electronic devices (e.g., a mobile device, a personal computer, a wearable electronic device, and/or a peripheral device) that is in communication with one or more display generation components (e.g., display 1002) and implements a digital assistant (e.g., digital assistant system 700, including foundation system 800 and/or task system 900). In some examples, system 1000 is implemented using a client-server system (e.g., system 100), and the functions of system 1000 are divided up in any manner between the server (e.g., DA server 106) and a client device (e.g., 104, 200, 400, and/or 600). In other examples, the functions of system 1000 are divided up between the server and multiple client devices. Thus, while some functions of system 1000 are described herein as being performed by particular devices of a client-server system, it will be appreciated that system 1000 is not so limited. In other examples, system 1000 is implemented using only a client device (e.g., 104, 200, 400, and/or 600) or only multiple client devices. Some functions of system 1000 are, optionally, combined, the order of some functions is, optionally, changed, and some functions are, optionally, omitted. In some examples, additional functions may be performed in combination with the described functions of system 1000.

At FIG. 10A, computer system 1000 displays, via display 1002, software object 1004, an electronic book (e.g., a user's digital copy of the book “Beach Read”) in a user interface for a reader application installed on computer system 1000. Referring momentarily to FIG. 10B, illustrating representations of software objects and intent data structures, software object 1004 (“Beach Read”) exists within the reader application as an instance of a BOOK object type. For example, the BOOK object type is a developer-defined (e.g., application-specific) object type, e.g., a class or type programmed for use within the reader application.

While displaying software object 1004, computer system 1000 receives a digital assistant request, such as request 1008A (“Open to page 75”), request 1008B (“Hey Assistant, add this to my summer reading list”), request 1008C (“Share this with Natalie”), and/or request 1008D (“Assistant, upload the training presentation to the cloud”). For example, the user request may include a natural-language speech input, a written or typed input, a gesture, and/or another input or sequence of inputs requesting that computer system 1000 perform a particular task, which can be pre-processed (e.g., initially interpreted) as described above with respect to digital assistant system 700 and/or foundation system 800. In some embodiments, the digital assistant request is explicitly directed to the digital assistant (e.g., using a trigger keyword, such as “Hey Assistant” in user request 1008B and/or “Assistant” in user request 1008D, or another trigger or invocation input, such as a button press, gesture, or gaze dwell). In some embodiments, the digital assistant request is a detected request that the digital assistant determines (e.g., using context information) it can assist in responding to. For example, the digital assistant request is received at response module 912, as described with respect to FIG. 9, above.

FIG. 10B illustrates example representations of a selection of software objects and intent data structures available to computer system 1000. For example, the representations of software objects and intent data structures illustrated in FIG. 10B are compiled and managed as described with respect to knowledge module 902 and the libraries of intents 904 and objects 906. In some embodiments, computer system 1000 obtains the representations of software objects and intent data structures prior to receiving requests 1008A-1008D, as described with respect FIG. 9.

As discussed above, software object 1004 is an instance of a BOOK object type (e.g., a user's digital copy of the book “Beach Read”) that exists within a reader application installed on computer system 1000. For example, the reader application “donates” the representation of software object 1004 to the digital assistant system of computer system 1000 as described with respect to FIG. 9. In addition to identifying software object 1004 as the specific instance of the BOOK object type, the representation of software object 1004 indicates a set of transferrable types for software object 1004, which are object types that software object 1004 could be converted (e.g., cast) into from the BOOK object type. As illustrated in FIG. 10B, the set of transferrable types for software object 1004 include a URL type (e.g., an address for a resource), a TEXT type (e.g., plain text, rich text, and/or text with markup), and a JPG type (e.g., a digital image in a JPEG format).

Software object 1006 is an instance of a PRESENTATION object type (e.g., a digital presentation titled “Training Presentation”), such as a digital presentation created within a presentation application and/or stored within a file system of computer system 1000. For example, the presentation application and/or file system “donates” the representation of software object 1006 to the digital assistant system of computer system 1000 as described with respect to FIG. 9. The representation of software object 1006 indicates a set of transferrable types for software object 1006, including a KEY type (e.g., a Keynote presentation file format), a PPT type (e.g., a PowerPoint presentation file format), a PDF type, and an HTML type.

Intent data structure 1010A is an intent data structure corresponding to a task of opening an item in the reader application. For example, intent data structure 1010A is an intent object donated by the reader application (e.g., via application module 908, as described above). As illustrated in FIG. 10B, intent data structure 1010A has an input field for a page number parameter (e.g., an optional parameter for specifying a page to open to) and an input field for an item to be opened. The representation of intent data structure 1010A specifies that the reader application can open objects of the BOOK object type (e.g., the reader application is capable of opening its own BOOK objects) or of a PDF object type.

Intent data structure 1010B is an intent data structure corresponding to a task of adding an item to a digital note in a Notes application (e.g., notes module 253). For example, intent data structure 1010B is an intent object donated by the Notes application. As illustrated in FIG. 10B, intent data structure 1010B has an input field for a target note (e.g., an optional parameter for specifying a particular, preexisting note and/or a title for a newly-created note) and an input field for an item to be added to the target note. The representation of intent data structure 1010B specifies that the Notes application can add JPG objects, GIF objects (e.g., digital images in a GIF format), URL objects, and TEXT objects to digital notes.

Intent data structure 1010C is an intent data structure corresponding to a task of adding an item to a playlist in a media player application. For example, intent data structure 1010C is an intent object donated by and/or compatible with the media player application. As illustrated in FIG. 10B, intent data structure 1010C has an input field for a target playlist and an input field for an item to be added to the target playlist. The representation of intent data structure 1010C specifies that the media player application can add AUDIO items and VIDEO items to playlists.

The AUDIO and VIDEO object types are hierarchical object types, for instance, superior type nodes in an object type hierarchy with one or more respective subordinate type nodes. For example, specifying the AUDIO object type as an accepted type for intent data structure 1010C indicates that the media player application can add any of a subordinate set of audio object types to a playlist, such as MP3, MP4, AAC, FLAC, WAV, MIDI, and/or other audio files or objects. For example, specifying the VIDEO object type as an accepted type for intent data structure 1010C indicates that the media player application can add any of a subordinate set of video object types to a playlist, such as MPEG, AVI, MOV, M4V, WebM, and/or other video file types or objects. In some embodiments, the object type hierarchy that defines the AUDIO and VIDEO object type nodes include standardized/system-defined types, but does not include developer-defined (e.g., application-specific) types.

Intent data structure 1010D is an intent data structure corresponding to a task of sharing an item with a contact, for instance, using a messaging application and/or a wireless communication protocol. As illustrated in FIG. 10B, intent data structure 1010D has an input field for a target contact and an input field for an item to be shared with the contact. The representation of intent data structure 1010D specifies that intent data structure 1010D accepts objects of the hierarchical object type ITEM. For example, the ITEM object type is a top-level hierarchical type node, indicating that all object types in the hierarchy can be shared using intent data structure 1010D. As discussed with respect to the AUDIO and VIDEO object types, in some embodiments, the ITEM object type includes all standardized/system-defined types, but does not include developer-defined (e.g., application-specific) types. For example, the ITEM object type does not include the BOOK object type, which is only defined within the reader application, but includes all of the BOOK object's transferrable types (e.g., the URL type, the JPG type, and the TEXT type).

Intent data structure 1010E is an intent data structure corresponding to a task of uploading an item to a cloud storage account, for instance, using a cloud storage application. As illustrated in FIG. 10B, the representation of intent data structure 1010E specifies that intent data structure 1010E accepts objects of the hierarchical object type DATA, which, for example, includes all standardized/system-defined readable or executable data file types. For example, the DATA object type includes the AUDIO, VIDEO, JPG, GIF, and/or PDF types.

FIG. 10C illustrates a response to request 1008A, “Open to page 75.” Computer system 1000 processes user request 1008A (e.g., as described with respect to digital assistant system 700 and FIG. 8) to determine that request 1008A corresponds to a request to open software object 1004 (e.g., the user's digital copy of the book “Beach Read”) to page number 75. For example, computer system 1000 may determine the requested task and the parameters of the task (e.g., the object to open and the page to open to) based on the language of request 1008A and/or related context information, such as display inspection information indicating that software object 1004 is being displayed when request 1008A is received (e.g., as described with respect to FIG. 9) and/or other metadata included with the representation of candidate software objects (e.g., metadata indicating that software object 1004 has at least 75 pages).

Computer system 1000 further determines that intent data structure 1010A corresponds to the requested task, for instance, based on the language of request 1008A and/or related context information, such as the display inspection information and/or metadata included with the representations of candidate intent data structures. In some embodiments, the related context information includes the representation of software object 1004. For example, upon determining that request 1008A is requesting performance of a task with software object 1004, computer system 1000 may narrow candidate intents down to the available intent data structures that can open either BOOK object types and/or at least one of software object 1004's specified transferrable types (e.g., URLs). In some embodiments, where more than one intent data structure capable of opening BOOK, URL, JPG, or TEXT object type is available to computer system 1000, computer system 1000 selects intent data structure 1010A based on intent data structure 1010A accepting the original, developer-defined type of software object 1004 (e.g., computer system 600 gives greater weight to intents that do not require conversion when determining how to respond using a particular software object).

Computer system 1000 then responds to request 1008A by populating intent data structure 1010A as illustrated in FIG. 10C, in particular, specifying value of 75 for the target page number (e.g., derived from the language of request 1008A and/or other context information, such as the user's last-accessed pages or bookmarks in software object 1004) and specifying software object 1004 as the item to open. As the representation of intent data structure 1010A indicates that BOOK object types are accepted, computer system 1000 can pass the representation of software object 1004 to the reader application as an input/parameter of intent data structure 1010A without converting (e.g., casting and/or exporting) software object 1004. Upon providing intent data structure 1010A and the representation of software object 1004 to the reader application, the reader application opens software object 1004 to the specified page, as illustrated in FIG. 10C.

FIGS. 10D-10F illustrate responses to request 1008B, “Add this to my summer reading list.” Computer system 1000 processes user request 1008B to determine that request 1008B corresponds to a request to add software object 1004 (e.g., the user's digital copy of the book “Beach Read”), or a representation thereof, to something else. For example, as described with respect to FIG. 10C, computer system 1000 identifies “this” as software object 1004 based on display inspection information and/or other available or obtained contextual information.

In some embodiments, based on an initial interpretation of request 1008B, computer system 1000 determines intent data structure 1010B (adding an item to a note in the Notes application) and intent data structure 1010C (adding an item to a playlist in a media player application) as candidate intents for responding to request 1008B, for example, based the representations of the intent data structures both identifying “add” as a corresponding natural-language keyword. In such embodiments, computer system 1000 selects between the candidate intents based on software object 1004 and the intent data structures' accepted input/parameter types.

In particular, computer system compares the sets of accepted input/parameter types for intent data structure 1010B and intent data structure 1010C to the current and transferrable types of software object 1004 to determine the overlap (e.g., the intersection between the accepted types for the input field and the set of transferrable types). As neither intent data structure 1010B nor intent data structure 1010C is an intent of the reader application, neither accepts the current type of software object 1004, the developer-defined BOOK object type. Intent data structure 1010B accepts the JPG, TEXT, and URL object types included in the set of transferrable types for software object 1004. Intent data structure 1010C accepts AUDIO and VIDEO object types, neither of which overlap with the transferrable types available for software object 1004.

Accordingly, computer system 1000 determines that intent data structure 1010B corresponds to the requested task to be performed with software object 1004. In order to populate intent data structure 1010B, computer system 1000 converts software object 1004 (e.g., as described with respect to conversion module 916) to one of a TEXT object, a URL object, and a JPG object.

As illustrated in FIG. 10D, computer system 1000 converts software object 1004 to text object 1004A, which is bibliographic text describing the book (e.g., “Beach Read by A. Author (2024)”), and provides intent data structure 1010B to the Notes application (e.g., via application module 908, as described above) populated with the title of the target note (e.g., as derived from request 1008B, a representation of the target note, and/or other contextual information) and text object 1004A. Providing the populated intent data structure 1010B to the Notes application causes the Notes application to insert text object 1004A into the text of the target note, as illustrated in FIG. 10D, where computer system 1000 displays the Notes application with text object 1004A in the note “My Summer Reading List.” Although FIG. 10D illustrates computer system 1000 displaying the result of executing intent data structure 1010B, it is to be understood that in some embodiments, providing intent data structure 1010B to the Notes application causes the Notes application to insert text object 1004A to the target note as a background process (e.g., without automatically displaying the Notes application).

In some embodiments, although software object 1004 and intent data structure 1010B have multiple overlapping types, computer system 1000 selects the TEXT object type to convert software object 1004, for example, ranking the overlapping types based on context information, such as the metadata for software object 1004 and/or intent data structure 1010B. For example, metadata supplied by the Notes application for intent data structure 1010B indicates that, while JPG, GIF, URL, and TEXT-type objects can all be included in notes generated, edited, and viewed within the Notes application, given the option, TEXT objects are preferred, followed by URL- and JPG-type objects, and GIF-type objects are least preferrable. As another example, computer system 1000 ranks the overlapping types based on comparative lossiness, data size, user preferences, and/or other system metrics (e.g., ranking lossless formats higher than lossy formats for optimized fidelity, or ranking more compressed formats higher than less compressed formats when operating in a restricted power or low data state). Accordingly, computer system 1000 automatically converts software object 1004 to text object 1004A and completes the response to request 1008.

Alternatively, as illustrated in FIG. 10E, given the multiple overlapping types for software object 1004 and intent data structure 1010B, computer system 1000 outputs prompt 1014 to select a transferrable type for exporting software object 1004 to the Notes application. For example, computer system 100 outputs prompt 1014 if no preferences have been specified for the transferrable types, if preferences specified by the respective donor applications contradict, and/or if computer system 1000 cannot rank the overlapping types with sufficient confidence based on the available contextual information. Prompt 1014 includes selectable element 1014A, corresponding to the TEXT object type, selectable element 1014B, corresponding to the JPG object type, and selectable element 1014C, corresponding to the URL object type. In some embodiments, alternatively or additionally to a displayed prompt such as 1014, computer system 1000 outputs another form of prompt, such as a spoken output (e.g., from the digital assistant system).

At FIG. 10E, computer system 1000 detects an input directed to selectable element 1014B, such as touch input 1016A and/or spoken input 1016B. At FIG. 10F, in response to detecting the input directed to selectable element 1014B, computer system 1000 converts software object 1004 to image object 1004B, a JPEG image file of the digital book's cover, and provides intent data structure 1010B to the Notes application populated with the title of the target note and image object 1004B. Providing the populated intent data structure 1010B to the Notes application causes the Notes application to insert image object 1004B into the body of the target note, as illustrated in FIG. 10E, where computer system 1000 displays the Notes application with image object 1004B in the note “My Summer Reading List.”

FIG. 10G illustrates a response to request 1008C, “Share this with Natalie.” Computer system 1000 processes request 1008C as described above to determine that request 1008C corresponds to a request to share software object 1004 with the contact Natalie, and that intent data structure 1010D corresponds to the requested task. As intent data structure 1010D is not an intent of the reader application (e.g., and does not accept the developer-defined BOOK object type), computer system 1000 selects the URL type from the overlapping set of software object 1004's transferrable types and intent data structure 1010D's accepted types. As described above, as the ITEM type is a top-level hierarchical object type, the overlapping set includes all of software object 1004's transferrable types, and computer system 1000 selects the URL type either automatically or by prompting the user for a selection (e.g., as described above with respect to FIGS. 10D-10F).

Accordingly, computer system 1000 response to request 1008C by converting software object 1004 to link object 1004C and providing intent data structure 1010D, populated with link object 1004C, to a messaging application compatible with intent data structure 1010D. Providing the messaging application with intent data structure 1010D and link object 1004C causes the messaging application to send a message to the contact Natalie with a link to the digital book. As discussed with respect to FIGS. 10D-10F, in some embodiments, intent data structure 1010D is executed as a background process, for instance, sending link object 1004C without automatically displaying the messaging application as illustrated.

FIG. 10H illustrates a response to request 1008D, “Upload the training presentation to my cloud.” Computer system 1000 processes request 1008D to determine that request 1008D corresponds to a request to upload software object 1006 (e.g., a digital presentation titled “Training Presentation”) to a cloud storage account. For example, although software object 1006 is not displayed when request 1008D is received, computer system 1000 identifies software object 1006 as the object to be uploaded based on the representations of objects available to computer system 1000 (e.g., searching the pre-compiled library of objects 906 for a software object associated with the words “training presentation”) and/or other available contextual information. Additionally, computer system 1000 identifies intent data structure 1010E as the intent corresponding to the requested task.

As illustrated in FIG. 10H, computer system 1000 converts software object 1006 to a KEY-type presentation object 1006A. As intent data structure 1010E is not an intent of the presentation application (e.g., and does not accept the developer-defined PRESENTATION object type), computer system 1000 selects the KEY type from the overlapping set of software object 1006's transferrable types and intent data structure 1010E's accepted types. As described above, as the DATA type is a higher-level hierarchical object type including many file types and formats, the overlapping set includes all of software object 1006's transferrable types, and computer system 1000 selects the KEY type either automatically or by prompting the user for a selection (e.g., as described above with respect to FIGS. 10D-10F). For example, the KEY type is selected based on metadata included in the representation of software object 1006 indicating that the KEY type is the preferred export format and/or other context information, such as the presentation file type the user typically uploads to their cloud account and/or the available storage space for the cloud storage account. As illustrated in FIG. 10H, in response to request 1008E, computer system 1000 populates intent data structure 1010E with presentation object 1006A and provides intent data structure 1010E to a cloud storage application, causing the cloud storage application to upload presentation object 1006A to the user's account.

FIG. 11 illustrates process 1100 for performing tasks using software objects, according to various examples. Process 1100 is performed, for example, using one or more electronic devices (e.g., 1000) implementing a digital assistant. In some examples, process 1100 is performed using a client-server system (e.g., system 100), and the blocks of process 1100 are divided up in any manner between the server (e.g., DA server 106) and a client device. In other examples, the blocks of process 1100 are divided up between the server and multiple client devices (e.g., a mobile phone, smart watch, personal computer, tablet device, headset, television, and/or other computing device). Thus, while portions of process 1100 are described herein as being performed by particular devices of a client-server system, it will be appreciated that process 1100 is not so limited. In other examples, process 1100 is performed using only a client device (e.g., user device 104) or only multiple client devices. In process 1100, some blocks are, optionally, combined, the order of some blocks is, optionally, changed, and some blocks are, optionally, omitted. In some examples, additional steps may be performed in combination with the process 1100.

The electronic device (e.g., 1000) receives (1102) a user request (e.g., 1008A, 1008B, 1008C, and/or 1008D) to perform (e.g., using the electronic device) an action with (e.g., using and/or with respect to) a respective software object (e.g., 1004, 1006) (e.g., a particular object instance, data item and/or application entity), wherein the action corresponds to an intent object (e.g., 1010A-1010E) of an application (e.g., the intent object, when provided to the application, causes the application to perform the action using one or more parameters of the intent object). In some embodiments, the respective software object exists within and/or is created, owned, or managed by a “donor” application installed on the electronic device, as described with respect to FIG. 9. For example, the request includes a request to use the respective software object (e.g., as an input, object, or subject) in performance of the action, e.g., requesting the action of inserting a particular photo object into an electronic note, the action of saving a particular presentation object to a cloud storage account, the action of associating a particular avatar object with an electronic contact, etc. In some embodiments, the request includes/is derived from a digital assistant request (e.g., the request is directed to a digital assistant). In some embodiments, the request includes/is derived from a natural language user input, such as a spoken or typed input, e.g., “Add this to my Note,” “Assistant, upload the training presentation to my cloud,” “Hey Assistant, save as Natalie's contact photo,” etc. In some embodiments, the request is pre-processed (e.g., using natural-language processing techniques, such as ontological methods, large language models, or the like) to identify the action, the respective software object, the application, and/or the intent object corresponding to the action.

In response to receiving the user request (1104) and in accordance with a determination that an entity type (in some embodiments, an object class and/or data format) of the respective software object (e.g., the software object's original or current type (e.g., the type of the entity within its donor application) is included in a set of parameter types accepted by the intent object of the application (e.g., the types of objects that can be used by the application to perform the action) (e.g., if there is no mismatch between the software object's original/current type and the type(s) the application can use to perform the action), the electronic device causes (1106) the application to perform the action with the respective software object (e.g., as described with respect to FIG. 10C). In some embodiments, the entity type of the respective software object is a developer-defined type of a respective application (e.g., the respective software object's donor application), which, in some embodiments, is only accepted by (e.g., compatible with) the respective application. For example, the software object's original/current type matches the parameter type(s) accepted by the intent object of the application if the application is the software object's donor application. In some embodiments, causing the application to perform the action with the respective software object includes providing the intent object to the application, e.g., with the respective software object (e.g., or a pointer/identifier of the respective software object) included as a parameter of the intent object.

In response to receiving the user request (1104) and in accordance with a determination that the entity type of the respective software object is not included in the set of parameter types accepted by the intent object of the application (1108) (e.g., if there is a mismatch between the entity's original/current type and the type(s) the application can use to perform the action), the electronic device converts (1110) the respective software object into a transferrable software object of a transferrable type selected from a set of transferrable parameter types for the respective software object (e.g., as described with respect to FIGS. 10D and 10F-10H). In some embodiments, the set of transferrable parameter types are non-developer defined types, e.g., standardized and/or system-defined types, as discussed with respect to FIG. 9. In some embodiments, converting the respective software object into a transferrable software object (e.g., 1004A, 1004B, 1004C, and/or 1006A) of the transferrable type includes obtaining the software object from the donor application and casting it into the selected transferrable type and/or requesting export of the software object from the donor application in the selected transferrable type (e.g., in the specified format).

In response to receiving the user request (1104) and in accordance with a determination that the entity type of the respective software object is not included in the set of parameter types accepted by the intent object of the application (1108), the electronic device provides (1112) the intent object of the application and the transferrable software object (e.g., as a parameter of the intent object) to the application to cause the application to perform the action with the transferrable software object (e.g., 1004A, 1004B, 1004C, and/or 1006A) (e.g., as described with respect to FIGS. 10D and 10F-10H).

In some embodiments, the user request to perform the action with the respective software object includes a natural-language input (e.g., a spoken or written user input) (e.g., as described with respect to FIG. 10A). In some embodiments, the natural-language input includes a speech input. In some embodiments, a natural-language input is processed to obtain a tokenized representation of the user request (e.g., converting speech or handwriting to text). In some embodiments, the electronic device performs additional pre-processing on the user request, for instance, to identify request domains, key words, candidate intents, and/or candidate objects (e.g., as described with respect to digital assistant system 700 and/or foundation system 800).

In some embodiments, the user request to perform the action with the respective software object is directed to a digital assistant system (e.g., as described with respect to FIG. 10A) (e.g., digital assistant system 700). For example, the request includes (or is accompanied by) a digital assistant trigger, the request is received during an ongoing digital assistant session, and/or the electronic device determines that the user request is something the digital assistant can help with.

In some embodiments, in response to receiving the user request, the electronic device identifies the intent object of the application (e.g., the intent object corresponding to the requested action) from a set of one or more intent objects (e.g., 904) (e.g., actionable intents available (e.g., registered) on the computer system/to the digital assistant system; from one or more applications including the application). For example, to respond to the user request, the electronic device identifies (e.g., selects/determines) an intent object corresponding to the requested action (e.g., an intent to add an item to a digital note, an intent to upload a file to a cloud storage service, or an intent to change a picture associated with a saved contact) from an overall set of available intent objects (e.g., a software toolkit populated by the applications and/or services of the computer system that is available to a digital assistant system). In some embodiments, the computer system identifies the intent object from the overall set of available intent objects based at least in part on context information and/or using natural-language processing techniques.

In some embodiments, identifying the intent object of the application from the set of one or more intent objects includes selecting the intent object of the application from a subset of the set of one or more intent objects (e.g., a subset of candidate request intents selected from the overall set of available intent objects), wherein the subset of the set of one or more intent objects includes intent objects that accept at least one of the entity type of the respective software object and a transferrable parameter type of the set of transferrable parameter types for the respective software object (e.g., the overall set of entity types for the respective software object) (e.g., as described with respect to FIG. 10D). For example, identifying the intent object corresponding to the requested action is constrained to the subset of intent objects that can accept the respective software object as a parameter, either in its original/current type or in a transferrable parameter type. In some embodiments, the computer system determines whether to include a respective intent object of the set of one or more intent objects in the subset of the set of one or more intent objects by comparing a set of parameter types accepted by a respective intent object in the set to the overall set of entity types for the respective software object. In some embodiments, if the subset of the set of one or more intent objects is empty, the computer system/digital assistant system returns an error. In some embodiments, types can be defined hierarchically, e.g., a “data” root type with leaf types including a plurality of file types, an “item” root type with leaf types including all system-defined object types, or an “image” root type with leaf types including a plurality of image file types (e.g., jpeg, gif, heic, png, etc.). Accordingly, if the set of parameter types accepted by the intent object of the application includes a root type, all of the leaf types are considered to be included in the set (e.g., as described with respect to intent data structures 1010C, 1010D, and 1010E).

In some embodiments, prior to receiving the user request, the electronic device populates (e.g., obtains from the one or more applications; e.g., registers for use with the digital assistant system) the set of one or more intent objects (e.g., 904, as described with respect to FIG. 9). For example, the computer system registers actionable intents available to the digital assistant system, such that when a request is received, the digital assistant can search the previously-registered overall intent set, e.g., without needing to poll applications and services for information related to their functionality. In some embodiments, intent objects include data structures representing actions or tasks that can be performed using the computer system, which can be provided to their associated applications to cause the applications to perform the actions or tasks using information included in the intent object.

In some embodiments, populating the set of one or more intent objects includes receiving a request to install the application and, in response to the request to install the application, installing the application and obtaining, from the application (in some embodiments, from the application's installation metadata), the intent object of the application to include in the set of one or more intent objects (e.g., as described with respect to FIG. 9). For example, when installing an application, the computer system fetches information about intent objects for the application and/or the application populates the set of intent objects with (e.g., donates) its intent objects upon installation. In some embodiments, the computer system updates the set of intent objects at other times, for instance, when an application is updated and/or when the application sends a push request to update its donated intent objects.

In some embodiments, in response to receiving the user request, the electronic device identifies the respective software object from a set of one or more software objects (e.g., 906) (e.g., object instances, data items, and/or application entities available on the computer system/to the digital assistant system). For example, to respond to the user request, the computer system identifies (e.g., selects/determines) the respective software object corresponding to the user request (e.g., the particular item corresponding to “this” in “Add this to my note,” the particular file corresponding to “the training presentation” in “Assistant, upload the training presentation to my cloud,” or the picture item implied in “Hey Assistant, save as Natalie's contact photo”) from an overall set of available software objects. In some embodiments, the computer system identifies the respective software object from the overall set of available software objects based at least in part on context information and/or using natural-language processing techniques.

In some embodiments, prior to receiving the user request, the electronic device populates (e.g., obtains from the one or more applications; e.g., registers for use with the digital assistant system) the set of one or more software objects (e.g., 906, as described with respect to FIG. 9). For example, the computer system registers software objects accessible to the digital assistant system, such that when a request is received, the digital assistant can search the previously-registered overall object set, e.g., without needing to poll applications and services for information about particular instances, data items, and/or application entities. In some embodiments, populating the set of one or more software objects includes obtaining, from at least one application (e.g., installed application; in some embodiments, from the application's installation, update, or push request metadata (e.g., in response to a request to install or update the application)), at least one software object to include in the set of one or more software objects.

In some embodiments, identifying the respective software object from the set of one or more software objects includes selecting the respective software object from a subset of the set of one or more software objects (e.g., a subset of candidate software objects selected from the overall set of available software objects), wherein the subset of the set of one or more software objects includes software objects that are displayed, via a display generation component of the computer system, when the user request is received (e.g., as described with respect to FIGS. 10C-10G). For example, identifying the software object with which to perform the requested action is informed by and/or constrained to the subset of software objects that are currently represented on a display. For example, the computer system/digital assistant system can inspect displayed content to determine the subset of software objects (e.g., the candidate software objects) (e.g., as described with respect to FIGS. 9 and 10C-10G). For example, the computer system can identify an image software object to add to a digital note based on the content displayed when the request “Add this to my Note” is received.

In some embodiments, converting the respective software object (e.g., 1004 and/or 1006) into the transferrable software object (e.g., 1004A, 1004B, 1004C, and/or 1006A) includes determining a subset of the set of transferrable parameter types for the respective software object, wherein the subset of the set of transferrable parameter types for the respective software object includes an intersection of the set of transferrable parameter types for the respective software object and the set of parameter types accepted by the intent object of the application, and selecting the transferrable type from the subset of the set of transferrable parameter types for the respective software object (e.g., as described with respect to FIGS. 10D-10H). In some embodiments, if the subset includes only one transferrable parameter type, the transferrable parameter type is automatically selected as the type for converting the software object.

In some embodiments, selecting the transferrable type from the subset of the set of transferrable parameter types for the respective software object includes, in accordance with a determination that the subset of the set of transferrable parameter types for the respective software object includes two or more transferrable parameter types, providing an output (e.g., 1014) (e.g., a displayed output, an audio output, and/or another type of output) requesting a selection of a respective transferrable parameter type from the subset of the set of transferrable parameter types for the respective software object (e.g., as described with respect to FIGS. 10E-10F). In some embodiments, the computer system/digital assistant system provides a spoken output, such as “Would you like to export this as a jpeg or a gif?” In some embodiments, the computer system provides a displayed output, such as the text “Export as .jpg or .gif?” and/or selectable user interface objects for two or more parameter types. In some embodiments, the output may indicate some or all of the subset of types (e.g., all available export types and/or the top-ranked export types). In some embodiments, selecting the transferrable type from the subset of the set of transferrable parameter types for the respective software object includes detecting a user input (e.g., 1016A and/or 1016B) including a selection of the transferrable parameter type (e.g., the transferrable type is selected for exporting the respective software object in response to the user input).

In some embodiments, selecting the transferrable type from the subset of the set of transferrable parameter types for the respective software object includes, in accordance with a determination that the subset of the set of transferrable parameter types for the respective software object includes two or more transferrable parameter types, obtaining a ranking of the subset of the set of transferrable parameter types for the respective software object (e.g., as described with respect to FIG. 10D). For example, the ranking may be obtained from the application's metadata, e.g., metadata indicating a developer ranking or preference for accepted entity types. For example, the ranking may be based on loss, compression, size, and/or computational load characteristics for the entity types (e.g., selecting the least-lossy transfer type, the most size-efficient transfer type, etc.).

In some embodiments, converting the respective software object (e.g., 1004 and/or 1006) into the transferrable software object (e.g., 1004A, 1004B, 1004C, and/or 1006A) includes requesting, from a respective application different from the application (e.g., the “donor” application), export of the respective software object in the transferrable type selected from the set of transferrable parameter types for the respective software object and receiving, from the respective application, the transferrable software object (e.g., as described with respect to FIG. 9). For example, the computer system/digital assistant system sends a request to the donor application identifying the requested software object and the selected transfer type.

The operations described above with reference to FIG. 11 are optionally implemented by components depicted in FIGS. 1-4A, 6A-6B, 7A-7C, 8, 9 and/or 10A-10H. For example, the operations of process 1100 may be implemented by may be implemented using task system 900, computer system 1000, as described above, and/or process 1200, as described below. It would be clear to a person having ordinary skill in the art how other processes are implemented based on the components depicted in FIGS. 1-4A, 6A-6B, 7A-7C, 8, 9 and/or 10A-10H.

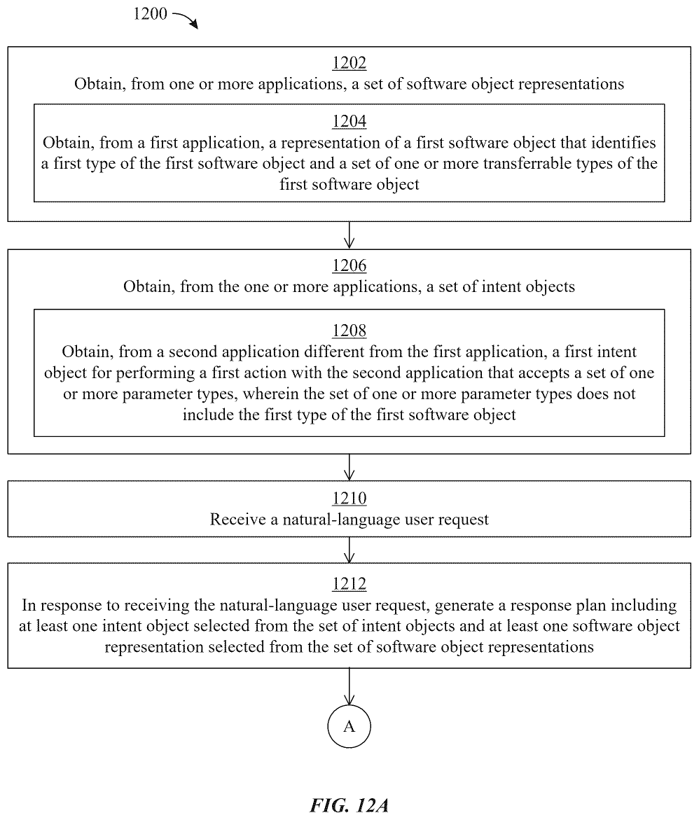

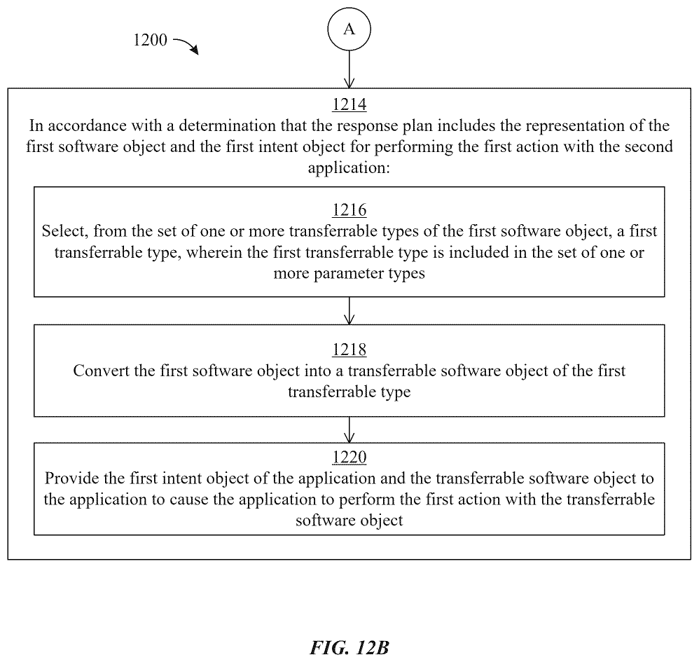

FIGS. 12A-12B illustrate process 1200 for performing tasks using software objects, according to various examples. Process 1200 is performed, for example, using one or more electronic devices (e.g., 1000) implementing a digital assistant. In some examples, process 1200 is performed using a client-server system (e.g., system 100), and the blocks of process 1200 are divided up in any manner between the server (e.g., DA server 106) and a client device. In other examples, the blocks of process 1200 are divided up between the server and multiple client devices (e.g., a mobile phone, smart watch, personal computer, tablet device, headset, television, and/or other computing device). Thus, while portions of process 1200 are described herein as being performed by particular devices of a client-server system, it will be appreciated that process 1200 is not so limited. In other examples, process 1200 is performed using only a client device (e.g., user device 104) or only multiple client devices. In process 1200, some blocks are, optionally, combined, the order of some blocks is, optionally, changed, and some blocks are, optionally, omitted. In some examples, additional steps may be performed in combination with the process 1200.

The electronic device obtains (1202), from one or more applications, a set of software object representations (e.g., 906) (e.g., identifiers, pointers, and/or metadata for one or more object instances, data items, and/or application entities). Obtaining the set of software object representations includes obtaining (1204), from a first application, a representation of a first software object (e.g., 1004 and/or 1006) (e.g., a particular object instance, data item, and/or application entity; in some embodiments, the software object exists within and/or is created, owned, or managed by the first application) that identifies a first type of the first software object (e.g., the software object's original or current type (e.g., the type of the software object within its donor application)) and a set of one or more transferrable types of the first software object (e.g., other than the respective type; e.g., types the respective software object can be cast as/converted into). In some embodiments, the type of the software object is a developer-defined (e.g., application-specific) type of the first application, for instance, and not a standardized and/or system-defined type. In some embodiments, the set of transferrable types are non-developer defined types, standardized and/or system-defined types.

The electronic device obtains (1206), from the one or more applications, a set of intent objects (e.g., 904). Obtaining the set of intent objects includes obtaining (1208), from a second application different from the first application, a first intent object (e.g., 1010A-1010E) for performing a first action with the second application (e.g., the intent object, when provided to the application, causes the application to perform the action) that accepts a set of one or more parameter types (e.g., the second application can perform the action using and/or with respect to items/objects of the set of accepted parameter types). The set of one or more parameter types (e.g., for the first intent object) does not include the first type of the first software object (e.g., a type mismatch exists between the respective software object and the respective intent) (e.g., as described with respect to software object 1004 and/or software object 10006 and intent data structures 1010B-1010E).

The electronic device receives (1210) a natural-language user request (e.g., 1008A-1008D) (e.g., a spoken or typed user input requesting performance of an action by the electronic device, e.g., “Add this to my Note,” “Assistant, upload the training presentation to my cloud,” “Hey Assistant, save as Natalie's contact photo,” etc.). In some embodiments, the natural-language user request includes a digital assistant request (e.g., the request is directed to a digital assistant) (e.g., as described with respect to FIG. 10A).

In response to receiving the natural-language user request, the electronic device generates (1212) (e.g., based at least in part on the natural-language user request) a response plan including at least one intent object selected from the set of intent objects and at least one software object representation selected from the set of software object representations (e.g., as described with respect to FIGS. 10C-10H). In some embodiments, the response plan identifies an intent corresponding to an action to be performed and one or more parameters for the intent, e.g., one or more inputs, objects, or subjects used for performing the action, e.g., an action of inserting a media item into an electronic note and a parameter identifying a particular photo as the media item, the action of saving an item to a cloud storage account and a parameter identifying a particular presentation file as the item, the action of associating a graphical item with an electronic contact and a parameter identifying the particular graphical item, etc. In some embodiments, the system generates one or more response plans in response to the user request, each identifying an intent and one or more parameters for the intent, e.g., to be executed sequentially in response to the user request.

In accordance with a determination that the response plan includes the representation of the first software object and the first intent object for performing the first action with the second application (1214) (e.g., if the response to the user request involves transferring the respective entity from the first application to the second application), the electronic device selects (1216), from the set of one or more transferrable types of the first software object, a first transferrable type, wherein the first transferrable type is included in the set of one or more parameter types (e.g., the parameter types accepted by the first intent object).

In accordance with a determination that the response plan includes the representation of the first software object and the first intent object for performing the first action with the second application (1214), the electronic device converts (1218) the first software object into a transferrable software object (e.g., 1004A, 1004B, 1004C, 1006A) of the first transferrable type. In some embodiments, converting the first software object into the transferrable software object includes obtaining the entity from the donor application and casting it into the selected transferrable type; in some embodiments, converting the first software object into the transferrable software object includes requesting export of the software object from the donor application in the selected transferrable type (e.g., in the specified format).

In accordance with a determination that the response plan includes the representation of the first software object and the first intent object for performing the first action with the second application (1214), the electronic device provides (1220) the first intent object of the application and the transferrable software object (e.g., 1004A, 1004B, 1004C, and/or 1006A) (e.g., as a parameter of the intent object) to the application to cause the application to perform the first action with the transferrable software object (e.g., as described with respect to FIGS. 10D and 10F-10H).

In some embodiments, obtaining the set of software object representations (e.g., 906) includes receiving a request to install a respective application of the one or more applications and, in response to receiving the request to install the respective application of the one or more applications, installing the respective application and obtaining, from the respective application (In some embodiments, from the application's installation metadata), a representation of at least one software object (e.g., 1004 and/or 1006) to include in the set of software object representations. For example, when installing an application, the computer system fetches information about software objects that exist within and/or are created, owned, and/or managed by the application and/or the application donates information about its software objects upon installation. In some embodiments, the computer system may update (e.g., donate to) the set of software object representations at other times, for instance, when an application is updated and/or when the application sends a push request. In some embodiments, the representation obtained from the respective application identifies an original/current type of the software object (e.g., the software object's type within the respective application) and a set of one or more transferrable types of the software object. In some embodiments, the set of transferrable types are types the respective application can export the software object as and/or convert the software object to.

In some embodiments, obtaining the set of software object representations (e.g., 906) includes obtaining display state information (e.g., as described with respect to FIG. 9) (e.g., inspecting the current display state) including a representation of at least one displayed software object (e.g., 1004) to include in the set of software object representations (e.g., as described with respect to FIG. 10C). For example, the set of software object representations includes representations of currently-displayed object instances, data items, and/or application entities. In some embodiments, the computer system/digital assistant system inspects display information in response to receiving the user request, e.g., to use as context for interpreting the natural-language user request. In some embodiments, the representation obtained from the display state information identifies an original/current type of a displayed software object and a set of one or more transferrable types of the displayed software object.

In some embodiments, obtaining the set of intent objects (e.g., 904) includes receiving a request to install a respective application of the one or more applications and, in response to receiving the request to install the respective application of the one or more applications, installing the respective application and obtaining, from the respective application (in some embodiments, from the application's installation metadata), at least one intent object (e.g., 1010A-1010E) to include in the set of intent objects. For example, when installing an application, the computer system fetches information about actionable intents that the application can handle and/or the application donates information about its actionable intents upon installation (e.g., as described with respect to FIG. 9). In some embodiments, the computer system may update (e.g., donate to) the set of intent objects at other times, for instance, when an application is updated and/or when the application sends a push request.

In some embodiments, obtaining the set of intent objects (e.g., 904) is performed prior to receiving the natural-language user request (e.g., as described with respect to FIG. 9). For example, the computer system/digital assistant system pre-compiles an actionable intent toolbox (e.g., 904). For example, the computer system registers actionable intents available to the digital assistant system, such that when a request is received, the digital assistant can search the previously-registered overall intent set, e.g., without needing to poll applications and services for information related to their functionality.

In some embodiments, generating the response plan includes identifying, based on the natural-language speech input, a respective software object, and selecting, from the set of software object representations (e.g., 906), a respective representation of the respective software object (e.g., 1004 and/or 1006) to include in the response plan, wherein the respective representation of the respective software object includes a respective type of the respective software object and a respective set of transferrable types of the respective software object. For example, the computer system identifies the respective software object from the overall set of available software objects based at least in part on context information and/or using natural-language processing techniques. For example, the computer system/digital assistant system determines the particular item corresponding to “this” in “Add this to my note,” the particular file corresponding to “the training presentation” in “Assistant, upload the training presentation to my cloud,” or the picture item implied in “Hey Assistant, save as Natalie's contact photo” and obtains the corresponding representation (e.g., an identifier, pointer, or other data object representing the identified software object).

In some embodiments, the electronic device obtains display state information indicating a set of visible software objects displayed, via a display generation component of the electronic device, when the natural-language user request is received (e.g., as described with respect to FIGS. 9 and/or 10C). In some embodiments, identifying the respective software object includes selecting the respective software object from the set of visible software objects. For example, selecting the software object with which to perform the requested action is informed by and/or constrained to the subset of software objects that are currently represented on a display. For example, the computer system/digital assistant system can inspect displayed content to obtain representations of currently-displayed software objects. In some embodiments, the display state information includes representations of the set of visible software objects. For example, the computer system can obtain a representation of a particular image software object to add to a digital note based on the image software object being displayed when the request “Add this to my Note” is received.

In some embodiments, generating the response plan includes determining a set of one or more candidate intent objects (e.g., a subset of the set of intent objects) including a candidate intent object for performing a candidate action with a candidate application (e.g., as described with respect to FIG. 10C). In some embodiments, the candidate intent object accepts a respective set of one or more parameter types. For example, the computer system identifies the respective software object from the overall set of available software objects based at least in part on context information and/or using natural-language processing techniques. For example, the computer system/digital assistant system determines candidate intent objects for an intent to “add,” such as an intent to add a media item to a digital note in a digital note application, an intent to create a calendar event in a calendar application, and an intent to save an audio media item to a playlist in a music player application.

In some embodiments, generating the response plan includes, in accordance with a determination that the response plan includes a representation of a respective software object (e.g., the software object with which an action will be performed in response to the natural-language user request), determining a set of candidate types that includes an intersection of the respective set of one or more parameter types and a superset of a respective type of the respective software object and a respective set of transferrable types of the respective software object (e.g., as described with respect to FIG. 10C). For example, the computer system compare's the candidate intent object's accepted parameter types to the original/current and transfer types of a software object included in the plan.

In some embodiments, in accordance with a determination that the set of candidate types is empty (e.g., as described with respect to software object 1004 and intent data structure 1010C), the electronic device foregoes including the candidate intent object in the response plan. In some embodiments, if there is another candidate intent in the set of one or more candidate intent objects, the computer system determines whether the other candidate intent accepts at least one type of the respective software object. In some embodiments, if there are no other candidate intents and/or none of the candidate intent objects accept at least one type of the respective software object, the computer system returns an error signal.

In some embodiments, in accordance with a determination that the set of candidate types includes the respective type of the respective software object (e.g., the original/current type of the respective software object; in some embodiments, a developer-defined type) (e.g., as described with respect to software object 1004 and intent data structure 1010A), the electronic device includes the representation of the candidate intent object in the response plan. For example, if a candidate intent is compatible with the original/current type of the software object, the candidate intent is selected. For example, the candidate intent may be compatible with the original/current type of the software object if the software object was donated by the candidate application (e.g., the software object exists within the candidate application and/or the candidate application created, owns, and/or manages the software object). In some embodiments, the electronic device provides the candidate application with the candidate intent object (in some embodiments, including the representation of the respective software object) to cause the candidate application to perform the candidate action with the respective software object (e.g., as described with respect to FIG. 10C). For example, the computer system/digital assistant system can provide the application with the intent object and the unconverted software object and/or a pointer to the unconverted software object (e.g., if the application donated the software object and can perform actions with the software object in its unconverted state).

In some embodiments, in accordance with a determination that the set of candidate types includes at least one of the respective set of transferrable types of the respective software object (e.g., the standardized/system-defined types the software object can be converted to) (e.g., as described with respect to software object 1004 and intent data structures 1010B, 1010D, and/or 1010E), the electronic device includes the representation of the candidate intent object in the response plan. For example, if a candidate intent is compatible with an available transfer type of the software object, the candidate intent is selected. In some embodiments, the representation of the candidate intent object is included in the response plan in accordance with a determination that the set of candidate types includes at least one of the respective set of transferrable types of the respective software object and a determination that the set of candidate types does not include the respective type of the respective software object (e.g., intents that accept the original/current type of the software object are prioritized).

In some embodiments, converting the first software object (e.g., 1004 and/or 1006) into a transferrable software object (e.g., 1004A, 1004B, 1004C, and/or 1006A) of the first transferrable type includes requesting, from a respective application different from the application (e.g., the “donor” application), export of the first software object in the first transferrable type, and receiving, from the respective application, the transferrable software object. For example, the computer system/digital assistant system sends a request to the donor application identifying the requested software object and the selected transfer type.

The operations described above with reference to FIGS. 12A-12B are optionally implemented by components depicted in FIGS. 1-4A, 6A-6B, 7A-7C, 8, 9 and/or 10A-10H. For example, the operations of process 1200 may be implemented using task system 900, computer system 1000, and/or process 1100, as described above. It would be clear to a person having ordinary skill in the art how other processes are implemented based on the components depicted in FIGS. 1-4A, 6A-6B, 7A-7C, 8, 9 and/or 10A-10H.

In accordance with some implementations, a computer-readable storage medium (e.g., a non-transitory computer readable storage medium) is provided, the computer-readable storage medium storing one or more programs for execution by one or more processors of an electronic device, the one or more programs including instructions for performing any of the methods or processes described herein.

In accordance with some implementations, an electronic device (e.g., a portable electronic device) is provided that comprises means for performing any of the methods or processes described herein.

In accordance with some implementations, an electronic device (e.g., a portable electronic device) is provided that comprises a processing unit configured to perform any of the methods or processes described herein.

In accordance with some implementations, an electronic device (e.g., a portable electronic device) is provided that comprises one or more processors and memory storing one or more programs for execution by the one or more processors, the one or more programs including instructions for performing any of the methods or processes described herein.

In accordance with some implementations, a computer system is provided that comprises means for performing any of the methods or processes described herein.

In accordance with some implementations, a computer system is provided that comprises a processing unit configured to perform any of the methods or processes described herein.

In accordance with some implementations, a computer system is provided that comprises one or more processors and memory storing one or more programs for execution by the one or more processors, the one or more programs including instructions for performing any of the methods or processes described herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the generation of responses to user requests, for instance, using a digital assistant. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to interpret and respond to user requests (e.g., determining corresponding intent and software objects). Accordingly, use of such personal information data provides context for digital assistant responses. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of generating responses to user requests with a digital assistant system, the present technology can be configured to allow users to select to “opt in” or “opt out” of participation in the collection of personal information data during registration for services or anytime thereafter. In another example, users can select not to provide mood-associated data for a digital assistant system. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, user requests can be interpreted and responded to by inferring preferences based on non-personal information data or a bare minimum amount of personal information, such as the content being requested by the device associated with a user, other non-personal information available to the digital assistant systems, or publicly available information.

What is claimed is:

1. An electronic device, comprising:
one or more processors;
a memory; and
one or more programs, wherein the one or more programs are stored in the memory and configured to be executed by the one or more processors, the one or more programs including instructions for:
obtaining, from one or more applications, a set of software object representations, wherein obtaining the set of software object representations includes obtaining, from a first application, a representation of a first software object that identifies a first type of the first software object and a set of one or more transferrable types of the first software object;
obtaining, from the one or more applications, a set of intent objects, wherein:
obtaining the set of intent objects includes obtaining, from a second application different from the first application, a first intent object for performing a first action with the second application that accepts a set of one or more parameter types; and
the set of one or more parameter types does not include the first type of the first software object;
receiving a natural-language user request;
in response to receiving the natural-language user request, generating a response plan including at least one intent object selected from the set of intent objects and at least one software object representation selected from the set of software object representations; and
in accordance with a determination that the response plan includes the representation of the first software object and the first intent object for performing the first action with the second application:
selecting, from the set of one or more transferrable types of the first software object, a first transferrable type, wherein the first transferrable type is included in the set of one or more parameter types;
converting the first software object into a transferrable software object of the first transferrable type; and
providing the first intent object of the application and the transferrable software object to the application to cause the application to perform the first action with the transferrable software object.

2. The electronic device of claim 1, wherein obtaining the set of software object representations includes:
receiving a request to install a respective application of the one or more applications; and
in response to receiving the request to install the respective application of the one or more applications:
installing the respective application; and
obtaining, from the respective application, a representation of at least one software object to include in the set of software object representations.

3. The electronic device of claim 1, wherein obtaining the set of software object representations includes:
obtaining display state information including a representation of at least one displayed software object to include in the set of software object representations.

4. The electronic device of claim 1, wherein obtaining the set of intent objects includes:
receiving a request to install a respective application of the one or more applications; and
in response to receiving the request to install the respective application of the one or more applications:
installing the respective application; and
obtaining, from the respective application, at least one intent object to include in the set of intent objects.

5. The electronic device of claim 1, wherein obtaining the set of intent objects is performed prior to receiving the natural-language user request.

6. The electronic device of claim 1, wherein generating the response plan includes:
identifying, based on the natural-language user request, a respective software object; and
selecting, from the set of software object representations, a respective representation of the respective software object to include in the response plan, wherein the respective representation of the respective software object includes a respective type of the respective software object and a respective set of transferrable types of the respective software object.

7. The electronic device of claim 6, the one or more programs further including instructions for:
obtaining display state information indicating a set of visible software objects displayed, via a display generation component of the electronic device, when the natural-language user request is received, wherein identifying the respective software object includes selecting the respective software object from the set of visible software objects.

8. The electronic device of claim 1, wherein:
generating the response plan includes determining a set of one or more candidate intent objects including a candidate intent object for performing a candidate action with a candidate application; and
the candidate intent object accepts a respective set of one or more parameter types.

9. The method of claim 8, wherein generating the response plan includes:
in accordance with a determination that the response plan includes a representation of a respective software object, determining a set of candidate types that includes an intersection of the respective set of one or more parameter types and a superset of a respective type of the first software object and a respective set of transferrable types of the first software object.

10. The electronic device of claim 9, the one or more programs further including instructions for:
in accordance with a determination that the set of candidate types is empty, foregoing including the candidate intent object in the response plan.

11. The electronic device of claim 9, the one or more programs further including instructions for:
in accordance with a determination that the set of candidate types includes the respective type of the respective software object, including the representation of the candidate intent object in the response plan.

12. The electronic device of claim 11, the one or more programs further including instructions for:
providing the candidate application with the candidate intent object to cause the candidate application to perform the candidate action with the respective software object.

13. The electronic device of claim 9, the one or more programs further including instructions for:
in accordance with a determination that the set of candidate types includes at least one of the respective set of transferrable types of the first software object, including the representation of the candidate intent object in the response plan.

14. The electronic device of claim 1, wherein converting the first software object into a transferrable software object of the first transferrable type includes:
requesting, from a respective application different from the first application, export of the first software object in the first transferrable type; and
receiving, from the respective application, the transferrable software object.

15. A non-transitory computer-readable storage medium storing one or more programs, the one or more programs comprising instructions, which when executed by one or more processors of an electronic device, cause the electronic device to:
obtain, from one or more applications, a set of software object representations, wherein obtaining the set of software object representations includes obtaining, from a first application, a representation of a first software object that identifies a first type of the first software object and a set of one or more transferrable types of the first software object;
obtain, from the one or more applications, a set of intent objects, wherein:
obtaining the set of intent objects includes obtaining, from a second application different from the first application, a first intent object for performing a first action with the second application that accepts a set of one or more parameter types; and
the set of one or more parameter types does not include the first type of the first software object;
receive a natural-language user request;
in response to receiving the natural-language user request, generate a response plan including at least one intent object selected from the set of intent objects and at least one software object representation selected from the set of software object representations; and
in accordance with a determination that the response plan includes the representation of the first software object and the first intent object for performing the first action with the second application:
select, from the set of one or more transferrable types of the first software object, a first transferrable type, wherein the first transferrable type is included in the set of one or more parameter types;
convert the first software object into a transferrable software object of the first transferrable type; and
provide the first intent object of the application and the transferrable software object to the application to cause the application to perform the first action with the transferrable software object.

16. A method comprising:
at an electronic device with one or more processors and memory:
obtaining, from one or more applications, a set of software object representations, wherein obtaining the set of software object representations includes obtaining, from a first application, a representation of a first software object that identifies a first type of the first software object and a set of one or more transferrable types of the first software object;
obtaining, from the one or more applications, a set of intent objects, wherein:
obtaining the set of intent objects includes obtaining, from a second application different from the first application, a first intent object for performing a first action with the second application that accepts a set of one or more parameter types; and
the set of one or more parameter types does not include the first type of the first software object;
receiving a natural-language user request;
in response to receiving the natural-language user request, generating a response plan including at least one intent object selected from the set of intent objects and at least one software object representation selected from the set of software object representations; and
in accordance with a determination that the response plan includes the representation of the first software object and the first intent object for performing the first action with the second application:
selecting, from the set of one or more transferrable types of the first software object, a first transferrable type, wherein the first transferrable type is included in the set of one or more parameter types;
converting the first software object into a transferrable software object of the first transferrable type; and
providing the first intent object of the application and the transferrable software object to the application to cause the application to perform the first action with the transferrable software object.
